(19) United States
(12) Patent Application Publication
(10) Pub. No.: US 2025/0299211 A1
(43) Pub. Date: Sep. 25, 2025

(54) DEMAND PREDICTION ASSISTANCE APPARATUS, DEMAND PREDICTION ASSISTANCE METHOD, AND RECORDING MEDIUM

(71) Applicant: NEC Corporation, Tokyo (JP)

(72) Inventors: Yudai YAMAGUCHI, Tokyo (JP); You IWAKAMI, Tokyo (JP); Izumi KUWATA, Tokyo (JP); Miki TANAKA, Tokyo (JP)

(73) Assignee: NEC Corporation, Tokyo (JP)

(21) Appl. No.: 19/001,737

(22) Filed: Dec. 26, 2024

(30) Foreign Application Priority Data
Mar. 25, 2024 (JP) 2024-048273

(51) Int. Cl. G06Q 30/0202; G06Q 30/0201

(52) U.S. Cl. CPC G06Q 30/0202; G06Q 30/0206

(57) ABSTRACT

A demand prediction assistance apparatus includes: a first displaying section for displaying, based on a plurality of indexes, information indicating a product which requires a prediction reassessment, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products; an accepting section for accepting a selection made by a user with respect to a product displayed by the first displaying section; and a second displaying section for displaying an analysis result regarding demand for a product corresponding to the selection accepted by the accepting section.

### CROSS REFERENCE TO RELATED APPLICATIONS

This application is based upon and claims the benefit of priority from Japanese Patent Application No. 2024-048273 filed on Mar. 25, 2024, the disclosure of which is incorporated herein in its entirety by reference.

### TECHNICAL FIELD

The present disclosure relates to a demand prediction assistance apparatus, a demand prediction assistance method, and a recording medium.

### BACKGROUND ART

Demand prediction techniques have been known. Examples of a demand prediction technique include the technique disclosed in Patent Literature 1. Patent Literature 1 discloses an order quantity proposal assistance system which includes a demand predicting section which uses a demand prediction model for predicting the demand for an item of interest to calculate a demand prediction value indicating demand prediction and an error predicting section which uses an error prediction model for predicting a future error in the demand prediction value to evaluate an error. In the order quantity proposal assistance system disclosed in Patent Literature 1, the demand predicting section extracts, from actual outcome data on the demand for the item of interest, features of the actual outcome data, and predicts the demand based on the features. The error predicting section predicts the error based on the actual outcome data, the demand prediction value, and the features.

### CITATION LIST

### Patent Literature

### [Patent Literature 1]

Japanese Patent Application Publication Tokukai No. 2020-102133

### SUMMARY OF INVENTION

### Technical Problem

A user who uses the result of the demand prediction, such as a planner, understands the accuracy of the demand prediction and carries out a product-by-product prediction reassessment or the like. In this case, a wider variety of products subjected to demand prediction leads to higher cost required for a product-by-product prediction reassessment or the like. Patent Literature 1 has a similar problem.

The present disclosure has been made in view of the above problem, and an example object thereof is to provide a technique which enables a user to efficiently carry out a product-by-product prediction reassessment.

### Solution to Problem

A demand prediction assistance apparatus in accordance with an example aspect of the present disclosure includes at least one processor, and the at least one processor carries out: a first displaying process of displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products; an accepting process of accepting a selection made by a user with respect to a product displayed in the first displaying process; and a second displaying process of displaying an analysis result regarding demand for a product corresponding to the selection accepted in the accepting process.

A demand prediction assistance method in accordance with n example aspect of the present disclosure includes: at least one processor displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;

the at least one processor accepting a selection made by a user with respect to a product displayed in the displaying of the information; and the at least one processor displaying an analysis result regarding demand for a product corresponding to the selection accepted in the accepting.

A recording medium in accordance with an example aspect of the present disclosure is a recording medium having recorded thereon a program for causing a computer to function as a demand prediction assistance apparatus, and the program causes the computer to carry out: a first displaying process of displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products; an accepting process of accepting a selection made by a user with respect to a product displayed in the first displaying process; and a second displaying process of displaying an analysis result regarding demand for a product corresponding to the selection accepted in the accepting process.

### Advantageous Effects of Invention

An example aspect of the present disclosure provides an example advantage of making it possible to provide a technique which enables a user to efficiently carry out a product-by-product prediction reassessment.

### BRIEF DESCRIPTION OF DRAWINGS

FIG. 1 is a block diagram illustrating a configuration of a demand prediction assistance apparatus in accordance with the present disclosure.

FIG. 2 is a flowchart illustrating a flow of a demand prediction assistance method in accordance with the present disclosure.

FIG. 3 is a diagram representing an example outline of a prediction ⋅ planning accuracy control operation in accordance with the present disclosure.

FIG. 4 is a block diagram illustrating a configuration of an accuracy control system in accordance with the present disclosure.

FIG. 5 is a block diagram illustrating a configuration of an information processing apparatus in accordance with the present disclosure.

FIG. 6 is a diagram illustrating an example computation of weighted MAPE in accordance with the present disclosure.

FIG. 7 is a diagram illustrating an example computation of an f-Bias ratio in accordance with the present disclosure.

FIG. 8 is a diagram illustrating an example computation of FVA in accordance with the present disclosure.

FIG. 9 is a diagram illustrating the outline of the transition of screens displayed by a display control section in accordance with the present disclosure.

FIG. 10 is a representation of an example of an overall summary screen in accordance with the present disclosure.

FIG. 11 is a representation of other examples of the graph displayed on the overall summary screen in accordance with the present disclosure.

FIG. 12 is a representation of still other examples of the graph displayed on the overall summary screen in accordance with the present disclosure.

FIG. 13 is a representation of an example of an assigned brand ⋅ category-specific information screen in accordance with the present disclosure.

FIG. 14 is a representation of other examples of the graph displayed on the assigned brand ⋅ category-specific information screen in accordance with the present disclosure.

FIG. 15 is a representation of still other examples of the graph displayed on the assigned brand ⋅ category-specific information screen in accordance with the present disclosure.

FIG. 16 is a representation of an example of a MAPE impact list screen in accordance with the present disclosure.

FIG. 17 is a representation of another example of the MAPE impact list screen in accordance with the present disclosure.

FIG. 18 is a representation of an example of a product-specific metrics analysis screen in accordance with the present disclosure.

FIG. 19 is a representation of other examples of the graph displayed on the product-specific metrics analysis screen in accordance with the present disclosure.

FIG. 20 is a representation of an example of an alert screen in accordance with the present disclosure.

FIG. 21 is a diagram visually illustrating the characteristics of alerts in accordance with the present disclosure.

FIG. 22 is a representation of an example of a predicted value reassessment screen in accordance with the present disclosure.

FIG. 23 is a block diagram illustrating an example configuration of a user terminal in accordance with the present disclosure.

FIG. 24 is a sequence diagram illustrating an example flow of a demand prediction assistance method in accordance with the present disclosure.

FIG. 25 is a sequence diagram illustrating an example flow of a demand prediction assistance method in accordance with the present disclosure.

FIG. 26 is a block diagram illustrating a configuration of a computer which functions as the demand prediction assistance apparatus and the information processing apparatus in accordance with the present disclosure.

### EXAMPLE EMBODIMENTS

The following description will discuss example embodiments of the present invention. However, the present invention is not limited to the example embodiments described below, but can be altered by a skilled person in the art within the scope of the claims. For example, any embodiment derived by appropriately combining techniques (some or all of products or methods) adopted in differing example embodiments described below can be within the scope of the present invention. Further, any embodiment derived by appropriately omitting one or more of the techniques adopted in differing example embodiments described below can be within the scope of the present invention. Furthermore, the advantage mentioned in each of the example embodiments described below is an example advantage expected in that example embodiment, and does not define the extension of the present invention. That is, any embodiment which does not provide the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is basic to each of the example embodiments which will be described later. It should be noted that the applicability of each of the techniques adopted in the present example embodiment is not limited to the present example embodiment. That is, each technique adopted in the present example embodiment can be adopted in another example embodiment included in the present disclosure, to the extent of constituting no specific technical obstacle. Further, each technique illustrated in the drawings referred to for the description of the present example embodiment can be adopted in another example embodiment included in the present disclosure, to the extent of constituting no specific technical obstacle.

### (Configuration of Demand Prediction Assistance Apparatus)

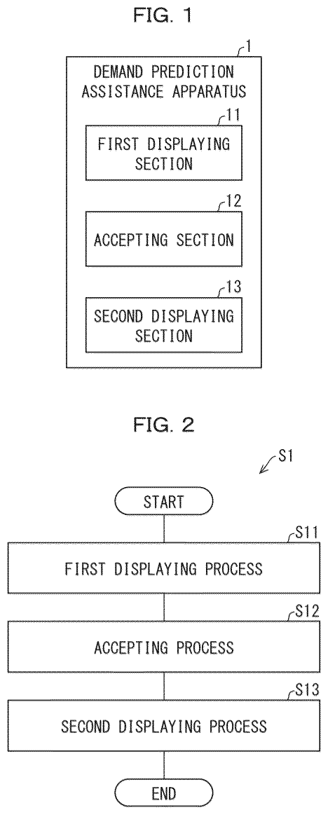

The configuration of a demand prediction assistance apparatus 1 is described here with reference to FIG. 1. FIG. 1 is a block diagram illustrating the configuration of the demand prediction assistance apparatus 1. The demand prediction assistance apparatus 1 includes a first displaying section 11, an accepting section 12, and a second displaying section 13, as illustrated in FIG. 1.

The first displaying section 11 displays, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products. The accepting section 12 accepts a selection made by a user with respect to a product displayed by the first displaying section 11. The second displaying section 13 displays an analysis result regarding demand for a product corresponding to the selection accepted by the accepting section 12.

### (Example Advantage of Demand Prediction Assistance Apparatus)

As above, the demand prediction assistance apparatus 1 includes: a first displaying section 11 for displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products; an accepting section 12 for accepting a selection made by a user with respect to a product displayed by the first displaying section 11; and a second displaying section 13 for displaying an analysis result regarding demand for a product corresponding to the selection accepted by the accepting section 12. Thus, the demand prediction assistance apparatus 1 provides an example advantage of making it possible for a user to efficiently carry out a product-by-product prediction reassessment.

### (Flow of Demand Prediction Assistance Method)

The flow of a demand prediction assistance method S1 is described here with reference to FIG. 2. FIG. 2 is a flowchart illustrating the flow of the demand prediction assistance method S1. The demand prediction assistance method S1 includes a first displaying process S11, an accepting process S12, and a second displaying process S13, as illustrated in FIG. 2.

In the first displaying process S11, at least one processor displays, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products. In the accepting process S12, the at least one processor accepts a selection made by a user with respect to a product displayed in the first displaying process S11. In the second displaying process S13, the at least one processor displays an analysis result regarding demand for a product corresponding to the selection accepted in the accepting process S12.

### (Example Advantage of Demand Prediction Assistance Method)

As above, the demand prediction assistance method S1 includes: a first displaying process S11 of at least one processor displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products; an accepting process S12 of the at least one processor accepting a selection made by a user with respect to a product displayed in the first displaying process S11; and a second displaying process S13 of the at least one processor displaying an analysis result regarding demand for a product corresponding to the selection accepted in the accepting process S12. Thus, the demand prediction assistance method S1 provides an example advantage of making it possible for a user to efficiently carry out a product-by-product prediction reassessment.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicability of each of the techniques adopted in the present example embodiment is not limited to the present example embodiment. That is, each technique adopted in the present example embodiment can be adopted in another example embodiment included in the present disclosure, to the extent of constituting no specific technical obstacle. Further, each technique illustrated in the drawings referred to for the description of the present example embodiment can be adopted in another example embodiment included in the present disclosure, to the extent of constituting no specific technical obstacle.

### (Overall Flow of Prediction ⋅ Planning Accuracy Control Operation)

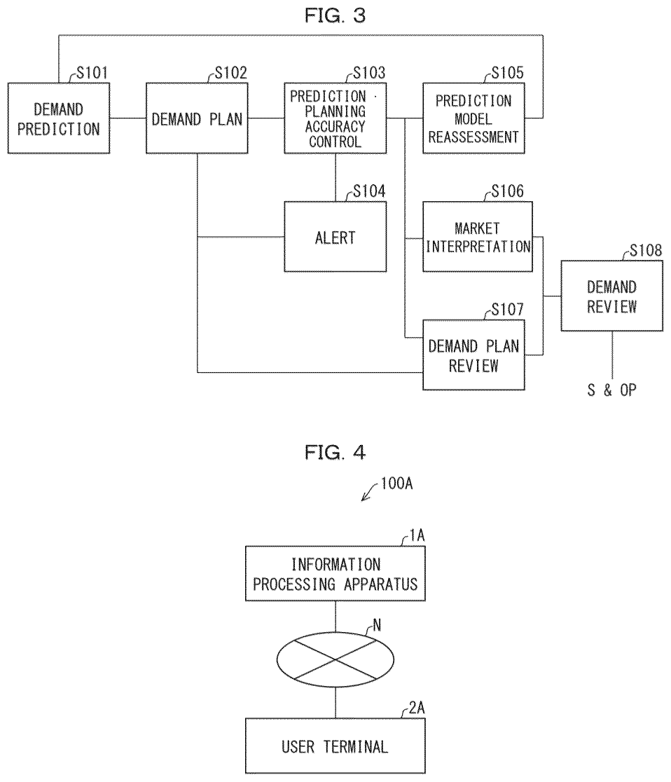

A demand prediction assistance system 100A (see FIG. 4) in accordance with the present disclosure controls the accuracy of demand predictions of a plurality of products. The overall picture of a prediction ⋅ planning accuracy control operation performed with use of the demand prediction assistance system 100A is described here with reference to FIG. 3. FIG. 3 is a diagram representing an example outline of a prediction ⋅ planning accuracy control operation in accordance with the present disclosure. First of all, in step S101, a demand prediction system uses a prediction model to make demand predictions of a plurality of products. A planner or the like creates a demand plan in step S102 on the basis of the results of the demand predictions.

In step S103, the demand prediction assistance system 100A (see FIG. 4) controls the accuracy of the demand prediction on the basis of the demand plan. In step S104, the demand prediction assistance system 100A outputs, on the basis of the demand plan, an alert regarding a product which requires a prediction reassessment. In step S105, the planner or the like reassesses the prediction model on the basis of the analysis result of the prediction accuracy, and in step S106, market interpretation is conducted on the basis of the analysis result of the prediction accuracy. In step S107, the planner or the like reviews the demand plan on the basis of the analysis result of the prediction accuracy, and reflects the result of the review in the demand plan. In step S108, the planner or the like conducts a demand review on the basis of the result of the market interpretation and the review of the demand plan, and carries out sales and operations planning (S & OP) on the basis of results of the demand review.

In the example of FIG. 3, the demand prediction system, which carries out step S101, may be the demand prediction assistance system 100A, which carries out step S103 and step S104, or may be a system other than the demand prediction assistance system 100A. Further, at least one of the above steps S102, S105, S106, S107, and S108 may be carried out by the demand prediction system or the demand prediction assistance system 100A.

### (Configuration of Demand Prediction Assistance System)

The configuration of the demand prediction assistance system 100A in accordance with the present disclosure is described here with reference to FIG. 4. FIG. 4 is a block diagram illustrating the configuration of the demand prediction assistance system 100A. The demand prediction assistance system 100A controls the accuracy of the demand predictions and the demand plan. The demand prediction assistance system 100A includes an information processing apparatus 1A and a user terminal 2A. The information processing apparatus 1A and the user terminal 2A are communicably connected together via a communication line N. A specific configuration of the communication line N does not limit the present example embodiment, but examples of the communication line include a wireless local area network (LAN), a wired LAN, a wide area network (WAN), a public network, a mobile data communication network, and a combination thereof.

The information processing apparatus 1A provides various services related to the accuracy of a demand prediction, and examples thereof include a general-purpose server. Further, the information processing apparatus 1A may be a personal computer such as a laptop personal computer or a tablet terminal. The user terminal 2A is the terminal which is used by a user (e.g. planner) who uses the above services, and examples thereof include a personal computer such as a laptop personal computer or a tablet terminal.

### (Configuration of Information Processing Apparatus)

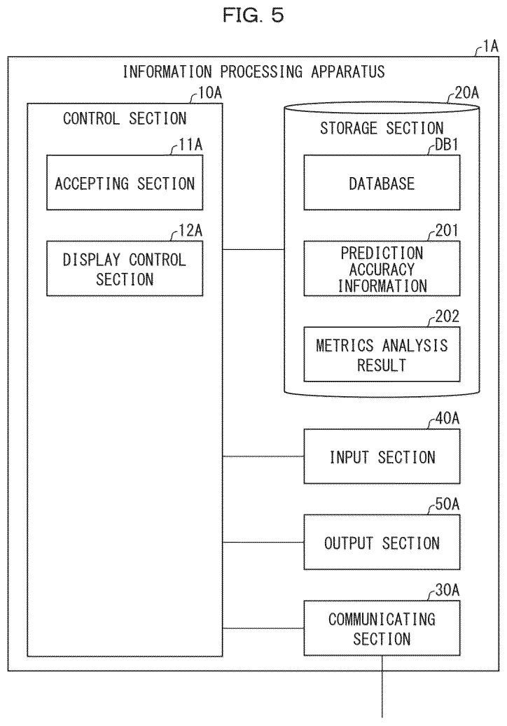

The configuration of the information processing apparatus 1A is described here with reference to FIG. 5. FIG. 5 is a block diagram illustrating the configuration of the information processing apparatus 1A. The information processing apparatus 1A includes a control section 10A, a storage section 20A, a communicating section 30A, an input section 40A, and an output section 50A. The communicating section 30A communicates with an apparatus (e.g. the user terminal 2A) external to the information processing apparatus 1A, via a communication line. The communicating section 30A transmits, to another apparatus, data supplied the control section 10A, and supplies the control section 10A with data received from another apparatus.

### (Input Section ⋅ Output Section)

The input section 40A is a component for accepting an input to the information processing apparatus 1A, and includes inputting equipment such as, for example, a keyboard, a mouse, a touch panel, a camera, or a microphone. Further, the input section 40A may be a component for accepting data from inputting equipment via an interface such as, for example, a universal serial bus (USB). The output section 50A is a component through which output from the information processing apparatus 1A is performed, and includes outputting equipment such as, for example, a display, a printer, a touch panel, or a speaker. The output section 50A includes an interface such as a USB for example, and may be a component for outputting data to outputting equipment via the interface.

### (Storage Section)

In the storage section 20A, various kinds of information to be referred to by the control section 10A are stored. Examples of such information include a database DB1, prediction accuracy information 201, and a metrics analysis result 202.

### (Database)

In the database DB1, information which indicates the product names, the identification information, the actual sales performance, the demand predictions, the brand types, the category types, the channel types, etc. of the plurality of products are stored. In the following description, the brand, the category, the channel, etc. are also referred to as a “class”.

### (Prediction Accuracy Information)

The prediction accuracy information 201 indicates the accuracy of demand predictions of the plurality of products. Examples of the prediction accuracy information 201 include mean absolute percentage error (MAPE), forecast-Bias (f-Bias) ratio, and forecast value added (FVA). However, the prediction accuracy information 201 is not limited thereto.

### (MAPE)

The MAPE is information which indicates the error ratio of a demand prediction to the actual sales performance of a product, and is used as an index based on which a prediction accuracy is evaluated. As an example, the MAPE is the average of the absolute values of values each obtained by dividing a subtraction result by the actual outcome value of a corresponding product, the subtraction result being obtained by subtracting the actual outcome value of the corresponding product from the predicted value of demand of the corresponding product. The actual outcome value here represents an actual sales performance, and is, for example, the actual outcome value of the amount of sales or the actual outcome value of the number of sales. The predicted value represents the result of a demand prediction, and is, for example, a predicted amount of sales or a predicted number of sales.

As an example, the MAPE of n products p₁, p₂, . . . , pₙ (n is a natural number not less than 1) is calculated from Formula (1) below. In Formula (1), yᵢ is the actual outcome value of sales of a product pᵢ in a target period, and \hat{ }yᵢ is the predicted value of demand for the product pᵢ in the target period. Note that the notation “\hat{ }yᵢ” represents “yᵢ hat”.

$$MAPE = \frac{100}{n} {\sum }_{i = 1}^{n} \vert \frac{{\hat{y}}_{i} - {y}_{i}}{{y}_{i}} \vert \qquad ( 1 )$$

### (Weighted MAPE)

The MAPE is not limited to Formula (1) above, but may be information obtained from the value obtained by weighting the error ratio of demand prediction of each of the products to the actual sales performance of that product according to the actual sales performance of that product. In the following description, such MAPE is referred to as “weighted MAPE” or also as “WAPE”. As an example, the weighted MAPE (WAPE) of n products p₁, p₂, . . . , pₙ is calculated from the following Formula (2).

$$WAPE = 100 {\sum }_{i = 1}^{n} \{ \frac{{y}_{i}}{{\sum }_{j = 1}^{n} {y}_{j}} \cdot \vert \frac{{\hat{y}}_{i} - {y}_{i}}{{y}_{i}} \vert \} \qquad ( 2 )$$

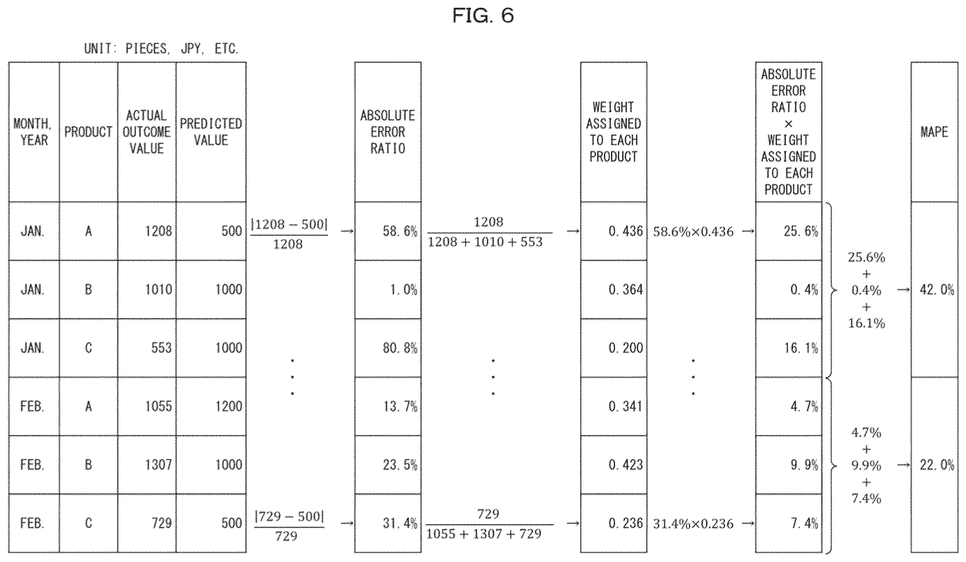

FIG. 6 is a diagram illustrating an example computation of the weighted MAPE. In the example of FIG. 6, the absolute error ratio and the weight value of each of products A, B, and C for January are calculated from the actual outcome values and the predicted values of the products for January, and the absolute error ratio and the weight value of each of the products A, B, and C for February are also calculated from the actual outcome values and the predicted values of the products for February. In addition, the sum of the results of multiplications of the absolute error ratio and the weight value of the respective products for January is calculated as the weighted MAPE for January, and the sum of the results of multiplications of the absolute error ratio and the weight value of the respective products for February is also calculated as the weighted MAPE for February.

(f-Bias Ratio)

The f-Bias ratio is information which indicates the trend in the error between prediction and plan. In the f-Bias ratio, a peculiarity of logic or a change in the market is manifested. As an example, the f-Bias ratio of n products p₁, p₂, . . . , pₙ is calculated from Formula (3) below. In Formula (3), yᵢ is the actual outcome value of sales of a product pᵢ in a target period, and \hat{ }yᵢ is the predicted value of demand for the product pᵢ in the target period.

$$\begin{matrix}f - Bias \\ ratio\end{matrix} = \frac{{\sum }_{i = 1}^{n} ( {\hat{y}}_{i} - {y}_{i} )}{{\sum }_{i = 1}^{n} {y}_{i}} \qquad ( 3 )$$

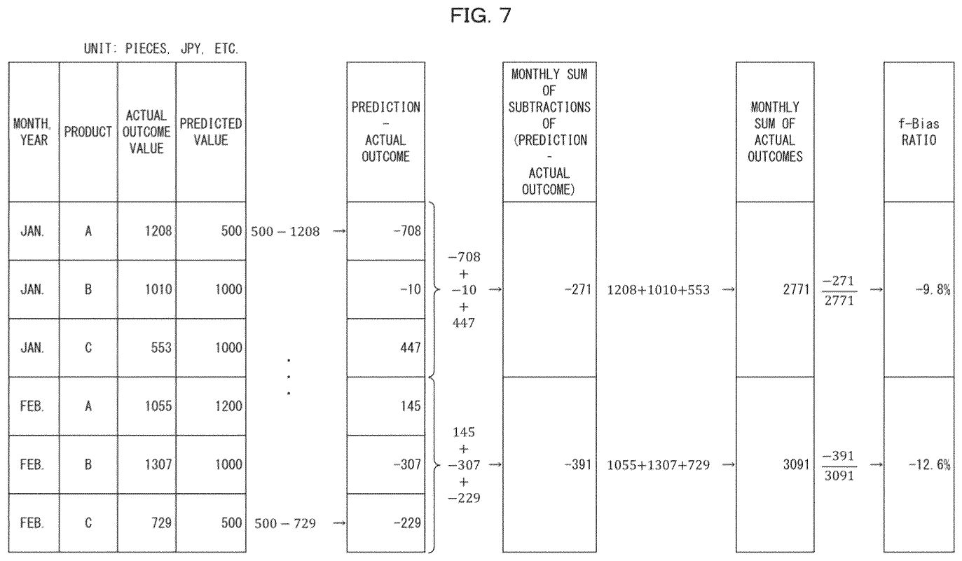

FIG. 7 is a diagram illustrating an example computation of the f-Bias ratio. In the example of FIG. 7, the f-Bias ratio for January is calculated from the actual outcome value and the predicted value of each of the products A, B, and C for January, and the f-Bias ratio for February is also calculated from the actual outcome value and the weight value of each of the products for February.

### (FVA)

The FVA is the index based on which added value of a demand prediction is evaluated in terms of monetary amounts. The FVA stands for forecast value added, and is information for judging whether a prediction result has produced value, compared with the result of a simple prediction. As an example, the FVA of n products p₁, p₂, . . . , pₙ (n is a natural number not less than 1) is calculated from Formula (4) below. In Formula (4), y_{i,k} is the actual outcome value of sales of the product pᵢ in a target period k, and y_{i,k-1} is the actual outcome value of sales of the product pᵢ in a period k−1 preceding the target period k. The term \hat{ }y_{i,k} is a predicted value of demand for the product pᵢ in the target period k. The term uᵢ is the unit price of the product pᵢ.

$$F V A = ( \vert {y}_{i , k - 1} - {y}_{i , k} \vert - \vert {\hat{y}}_{i , k} - {y}_{i , k} \vert ) \cdot {u}_{i} \qquad ( 4 )$$

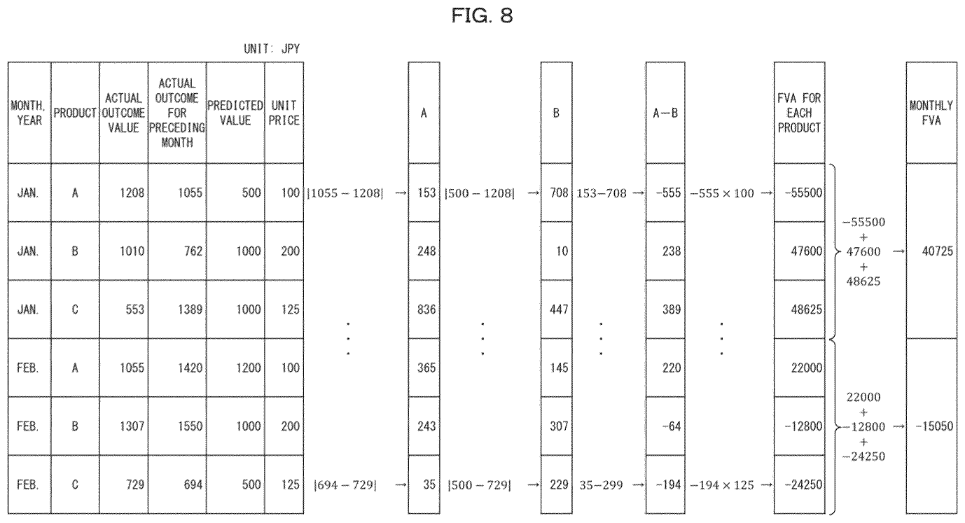

FIG. 8 is a diagram illustrating an example computation of the FVA. In the example of FIG. 8, the FVA for January and the FVA for February are calculated from the actual outcome values for December to February and the predicted values for January and February of the products A, B, and C. However, with what the comparison is made in predictions in the FVA is not limited to the actual outcome for the preceding month. For example, the FVA may be calculated by comparison with the actual outcome for the preceding year, or may be calculated by comparison with the moving average.

### (Metrics Analysis Results)

In order to properly identify the factors of a prediction error (various metrics) through analysis, it is effective to analyze the movement in the channel-specific sales and composition ratio, make comparisons with the preceding year and with the second preceding year, and make compositions of final consumption, wholesale shipping, and maker shipping. The metrics analysis refers to considering these analysis and comparisons together. The metrics analysis results are the results of analysis of various kinds of information related to a demand prediction carried out product by product.

### (Control Section)

The control section 10A includes an accepting section 11A and a display control section 12A.

### (Accepting Section)

The accepting section 11A accepts various instructions or selections made by a user. As an example, the accepting section 11A accepts the instructions or selections by receiving, from the user terminal 2A, data which indicates an instruction or selection made by a user. Further, the accepting section 11A may accept an instruction or selection inputted by a user to the input section 40A.

### (Display Control Section)

The display control section 12A outputs data representing various screens to a display, to display the screens on the display. As an example, the display is the display of the user terminal 2A. In this case, the display control section 12A transmits the data representing various screens to the user terminal 2A via the communicating section 30A, and causes the screens to be displayed on the display of the user terminal 2A. Herein, the display control section 12A transmitting data which represents a screen to the user terminal 2A to cause the screen to be displayed on the display of the user terminal 2A is also expressed as “the display control section 12A displays the screen”.

The display control section 12A may output data representing a screen to a display connected to the output section 50A, to cause the screen to be displayed on the display.

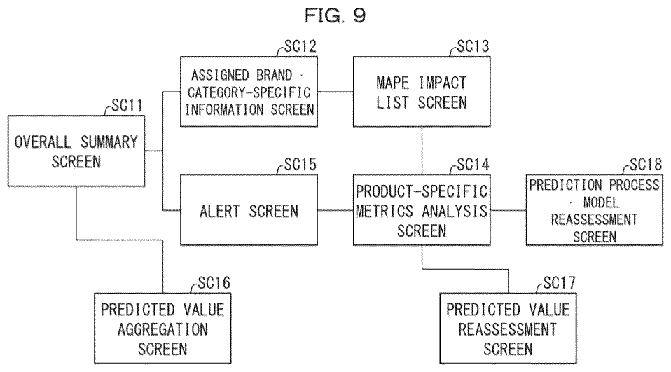

FIG. 9 is a diagram illustrating the outline of the transition of screens displayed by the display control section 12A on the display. Displayed by the display control section 12A in the example of FIG. 9 are an overall summary screen SC11, a brand ⋅ category-specific information screen SC12, an MAPE impact list screen SC13, a product-specific metrics analysis screen SC14, an alert screen SC15, a predicted value aggregation screen SC16, a predicted value reassessment screen SC17, and a prediction process ⋅ model reassessment screen SC18.

### (Overall Summary Screen)

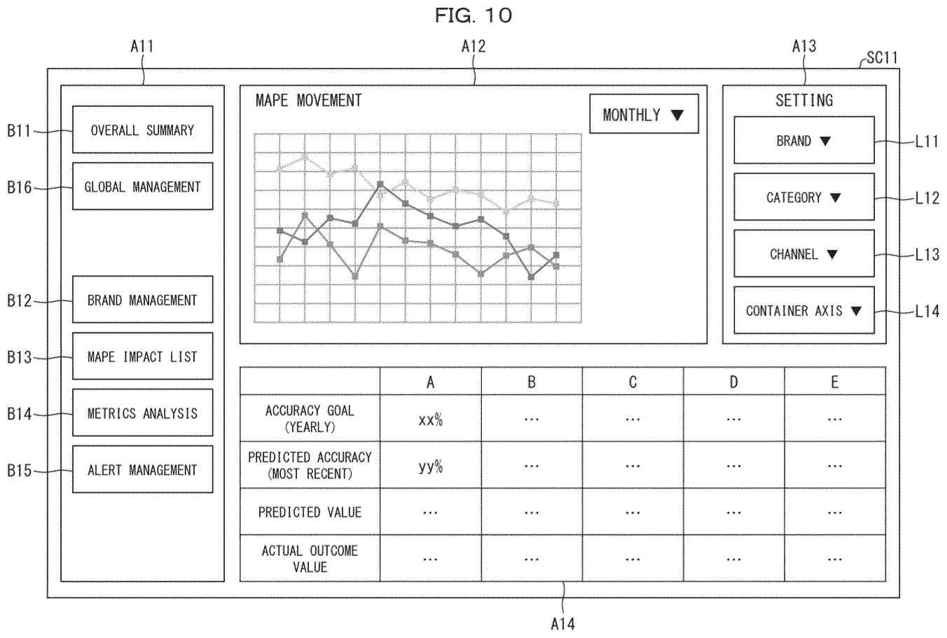

The overall summary screen SC11 is a screen on which the overall summary of services provided by the information processing apparatus 1A are displayed. FIG. 10 is a representation of an example of the overall summary screen SC11. In the example of FIG. 10, the overall summary screen SC11 includes a menu area A11, a graph display area A12, a setting area A13, and a table display area A14.

The menu area A11 includes buttons B11 to B16. The buttons B11, B12, B13, B14, B15, and B16 are for causing a screen to transition to the overall summary screen SC11, the category-specific information screen SC12, the MAPE impact list screen SC13, the product-specific metrics analysis screen SC14, the alert screen SC15, and the predicted value aggregation screen SC16, respectively. Upon performance, by a user, of the operation of selecting any of the buttons B11 to B16, the display control section 12A displays, on the display, a screen corresponding to the selected button.

The graph display area A12 is an area in which to display information indicating the accuracy of a demand prediction. As an example, the display control section 12A displays, in the graph display area A12, a graph which represents the movement in the MAPE for one month. In the graph displayed in the graph display area A12 of the example of FIG. 10, the horizontal axis indicates time and date, and the vertical axis indicates the MAPE.

The setting area A13 includes pull-down lists L11 to L14 for a user to select the class of a product. The pull-down lists L11, L12, L13, and L14 are for designating “brand”, “category”, “channel”, and “container types”, respectively. Upon selection of a class by a user via any of the pull-down lists L11 to L14, the display control section 12A displays, in the graph display area A12, information indicating the accuracy of the demand prediction of a product belonging to the selected class.

The table display area A14 is an area in which to display the demand predictions and the actual outcomes of a plurality of products which belong to a class selected by a user. In the example of FIG. 10, the display control section 12A displays, in the table display area A14, an accuracy goal, a prediction accuracy, a predicted value, an actual outcome value for each of the products A to E.

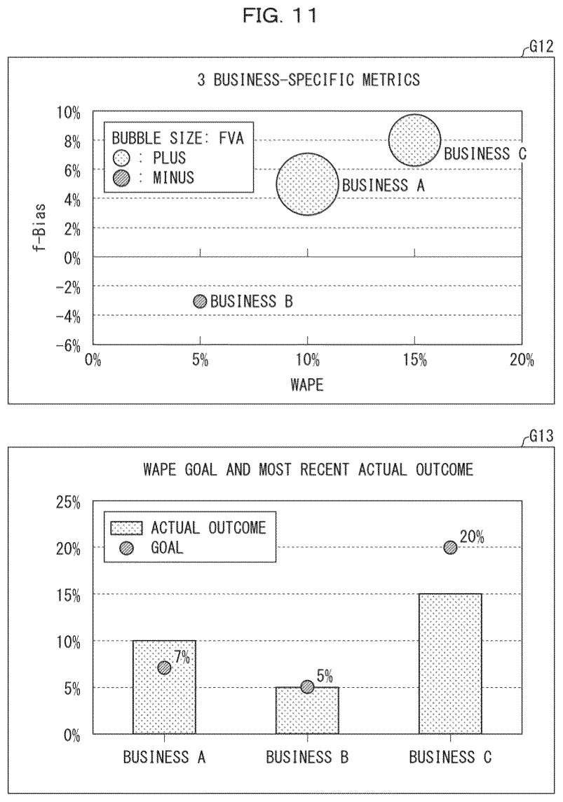

FIG. 11 is a representation of other examples of the graph displayed on the overall summary screen SC11. In the examples of FIG. 11, a graph G12 represents the accuracy of a demand prediction, and the horizontal axis indicates the MAPE and the vertical axis indicates the f-Bias ratio. Further, the bubble size indicates the FVA. A graph G13 represents the actual outcome value and the goal value of the MAPE of each of business A, B, and C.

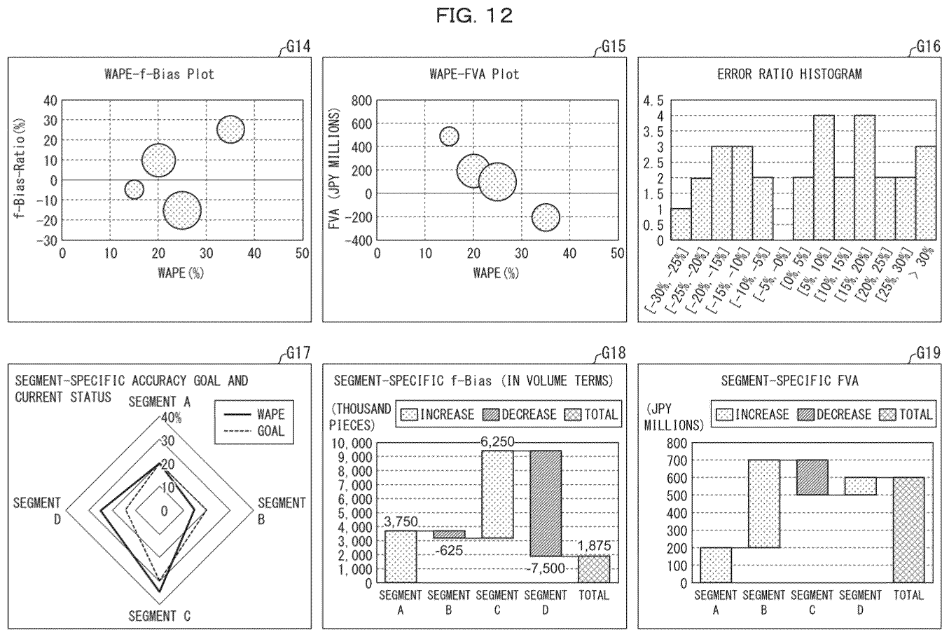

FIG. 12 is a representation of still other examples of the graph displayed on the overall summary screen SC11. In the examples of FIG. 12, graphs G14 to G19 each represent the accuracy of a demand prediction. In the graph G14, the horizontal axis indicates the WAPE, and the vertical axis indicates the f-Bias ratio. Further, the bubble size indicates the scale of sales of each segment. In the graph G15, the horizontal axis indicates the WAPE, and the vertical axis indicates the FVA. Further, the bubble size indicates the scale of sales of each segment. The graph G16 is an error ratio histogram. The graph G17 represents a segment-specific accuracy goal and segment-specific current WAPE. The graph G18 represents a segment-specific f-Bias ratio. The graph G19 represents segment-specific FVA.

### (Assigned Brand ⋅ Category-Specific Information Screen)

The assigned brand ⋅ category-specific information screen SC12 includes a plurality of pieces of information which represent the accuracies of demand predictions of a plurality of products belonging to a class designated by a user. In other words, the display control section 12A displays, on the assigned brand ⋅ category-specific information screen SC12, a plurality of pieces of information which represent the accuracies of demand predictions of a plurality of products belonging to a class designated by a user. Examples of the information that indicates the accuracy of a demand prediction of a product includes MAPE, weighted MAPE, an f-Bias ratio, and FVA. In other words, it can also be said that the display control section 12A displays MAPE, weighted MAPE, an f-Bias ratio, and FVA on the assigned brand ⋅ category-specific information screen SC12. The MAPE to be displayed may be weighted MAPE. However, the information indicating the accuracy of the demand prediction of a product is not limited to the above example.

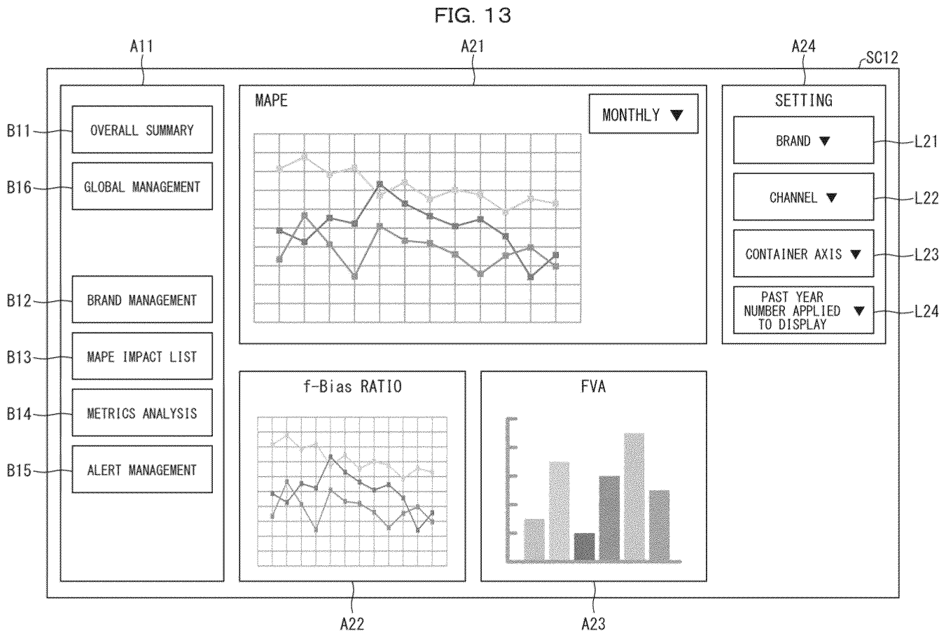

FIG. 13 is a representation of an example of the assigned brand ⋅ category-specific information screen SC12. Upon selection of the button B12 by a user on the overall summary screen SC11 of FIG. 10, the display control section 12A causes the displayed screen to transition from the overall summary screen SC11 to the assigned brand ⋅ category-specific information screen SC12. In the example of FIG. 13, the assigned brand ⋅ category-specific information screen SC12 includes a menu area A11, accuracy information display areas A21 to A23, and a setting area A24. The menu area A11 is the same as the menu area A11 included in the overall summary screen SC11 of FIG. 10.

The accuracy information display areas A21, A22, and A23 are regions in which to display the graphs of the MAPE, the f-Bias ratio, and the FVA, respectively. The display control section 12A displays, in the accuracy information display areas A21 to A23, the MAPE, the f-Bias ratio, and the FVA which represent the accuracy of the demand prediction of a product belonging to a class designated by a user with use of pull-down lists L21 to L24 of the setting area A24.

The setting area A24 includes the pull-down lists L21 to L24 for a user to select a class of a product. The pull-down lists L21, L22, L23, and L24 are for designating “brand”, “channel”, “container types”, “past year number applied to display”. Upon selection of a class by a user via any of the pull-down lists L21 to L24, the display control section 12A displays, in the accuracy information display areas A21 to A23, accuracy information regarding a product belonging to the selected class.

The menu area A11 includes buttons B11 to B16. The buttons B11, B12, B13, B14, B15, and B16 are for causing transitions to the overall summary screen SC11, the category-specific information screen SC12, the MAPE impact list screen SC13, the product-specific metrics analysis screen SC14, the alert screen SC15, and the predicted value aggregation screen SC16, respectively. Upon performance, by a user, of the operation of selecting any of the buttons B11 to B16, the display control section 12A displays a screen corresponding to the selected button. In particular, upon selection of the button B13 by a user, the display control section 12A displays the MAPE impact list screen SC13. In other words, it can also be said that on the assigned brand ⋅ category-specific information screen SC12, the accepting section 11A accepts the instruction that a prediction accuracy should be displayed product by product.

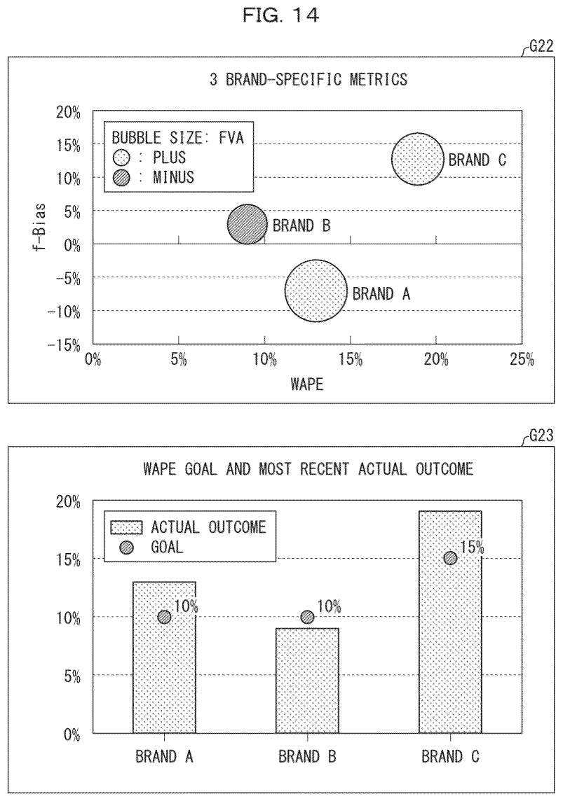

FIG. 14 is a representation of other examples of the graph displayed in the accuracy information display areas A21 to A23 of the assigned brand ⋅ category-specific information screen SC12. In the examples of FIG. 14, a graph 22 represents the accuracy of a demand prediction, and the horizontal axis indicates the MAPE and the vertical axis indicates the f-Bias ratio. Further, the displayed bubble size indicates the FVA.

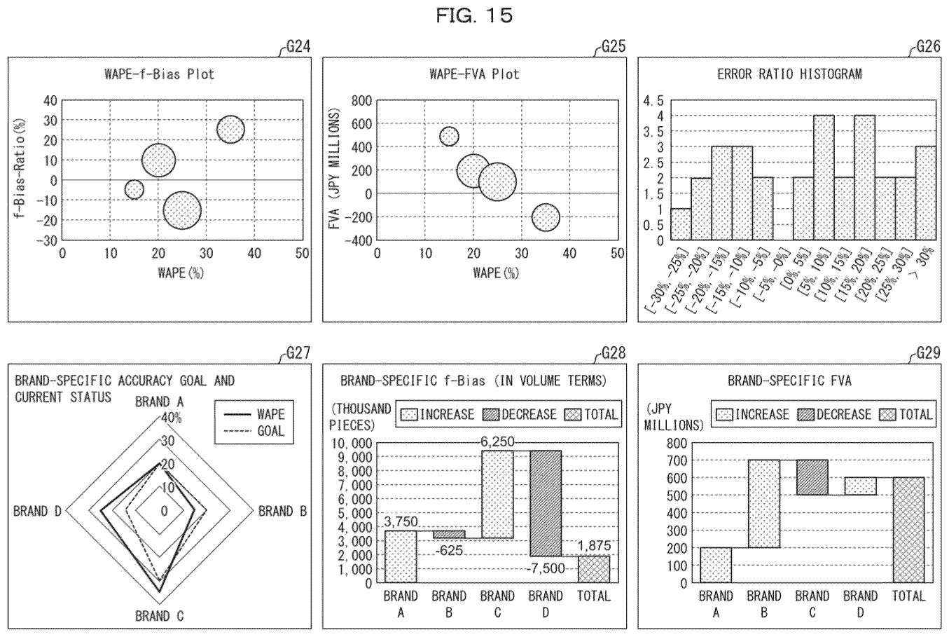

FIG. 15 is a representation of still other examples of the graph displayed on the assigned brand ⋅ category-specific information screen SC12. In the examples of FIG. 15, graphs G24 to G29 each represent the accuracy of a demand prediction of each class such as a brand or a category. In the graph G24, the horizontal axis indicates the WAPE, and the vertical axis indicates the f-Bias ratio. Further, the bubble size indicates the scale of sales of each segment. In the graph G25, the horizontal axis indicates the WAPE, and the vertical axis indicates the FVA. Further, the bubble size indicates the scale of sales of each segment. The graph G26 is an error ratio histogram. The graph G27 represents a brand-specific accuracy goal and brand-specific current WAPE. The graph G28 represents a brand-specific f-Bias ratio. The graph G29 represents brand-specific FVA.

### (MAPE Impact List Screen)

The MAPE impact list screen SC13 includes a list of products based on MAPE impact. The MAPE impact is an index obtained by multiplying the absolute value of the demand prediction error ratio of each of the products by the weight value of that product. More specifically, as an example, the MAPE impact is a value obtained by multiplying the absolute error ratio (the value obtained by dividing the difference between the predicted value and the actual outcome value of sales by the actual outcome value) of each of the products by the weight value of that product. As an example, the weight value is determined according to the actual outcome value of sales of a product. A product having a larger scale of sales and a larger error has a larger MAPE impact value. With the MAPE impact, it is possible to know a product having a large prediction accuracy error and a large scale of sales. This makes it possible to understand a product the demand prediction of which should be preferentially reassessed.

In other words, it can be said that in a case where the accepting section 11A accepts the instruction that the MAPE impact list screen should be displayed, the display control section 12A displays, based on the MAPE impact, information which indicates a product which has a high possibility of requiring a prediction reassessment, regarding the plurality of products belonging to the class designated by a user, on the MAPE impact list screen SC13.

More specifically, the MAPE impact list is a list of a plurality of products sorted in descending order of the MAPE impact. In other words, it can be said that the display control section 12A displays a list of a plurality of products sorted in descending order of the MAPE impact.

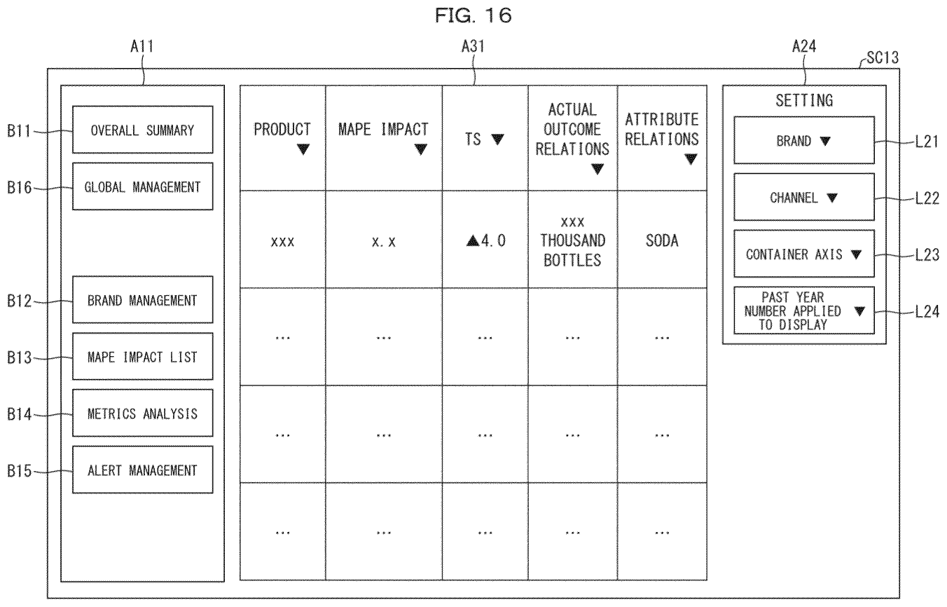

FIG. 16 is a representation of an example of the MAPE impact list screen SC13. Upon selection of the button B13 by a user on the assigned brand ⋅ category-specific information screen SC12 illustrated in FIG. 13, the display control section 12A causes the screen on the display to transition from the assigned brand ⋅ category-specific information screen SC12 to the MAPE impact list screen SC13. In the example of FIG. 16, the MAPE impact list screen SC13 includes a menu area A11, a list display area A31, and a setting area A32. The menu area A11 is the same as the menu area A11 included in the overall summary screen SC11 of FIG. 10. Further, the setting area A24 is the same as the setting area A24 included in the assigned brand ⋅ category-specific information screen SC12 of FIG. 13.

The list display area A31 is an area in which to display a list of products sorted by the MAPE impact. In the example of FIG. 16, in the list display area A31, a plurality of records in each of which the items of “product”, “MAPE impact”, “TS”, “actual outcome relations”, and “attribute relations” are associated with each other are displayed. Among these items, displayed in the item of “product” is information (e.g. product name, product ID, or the like) for identifying a product, and displayed in the item of “MAPE impact” is the MAPE impact of the product. In the item of “TS”, the TS (tracking signal) of the product is displayed. A method for calculating TS will be described later. In the item of “actual outcome relations”, information indicating the actual sales performance of the product is displayed. In the item of “attribute relations”, information indicating the attribute of the product is displayed. In a case where an item other than that of the MAPE impact is selected by a user in the list displayed in the list display area A31, the result of sorting the products according to the values of the selected item may be displayed.

On the MAPE impact list screen SC13, the accepting section 11A accepts the selection of a product included in the list of products sorted by the MAPE impact. Upon the selection of a product by a user from the list, the display control section 12A displays the product-specific metrics analysis screen SC14 regarding the selected product.

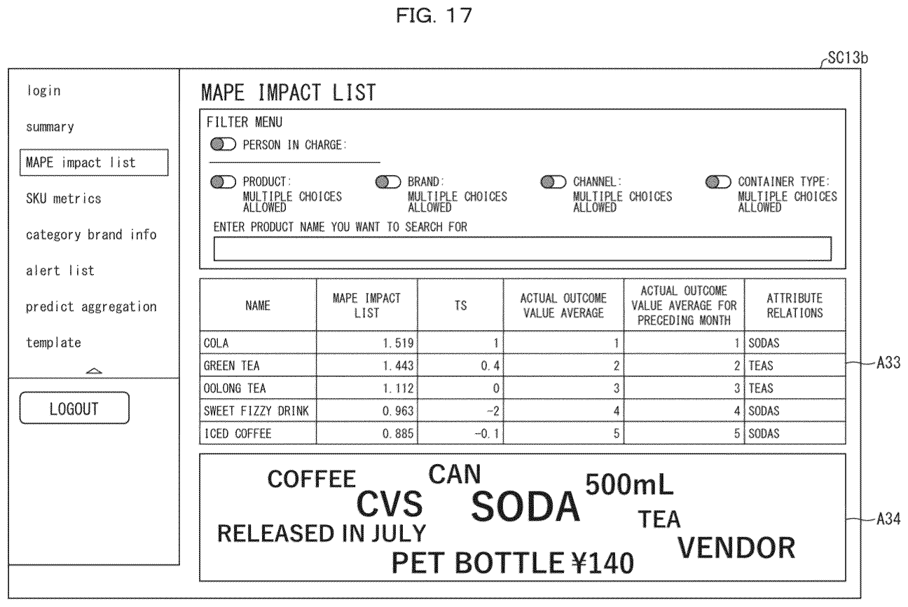

FIG. 17 is a representation of another example of the MAPE impact list screen SC13. In the example of FIG. 17, the MAPE impact list screen SC13b includes a list display area A33 and a word cloud display area A34 In the list display area A33, a list of products sorted by the MAPE impact is displayed. In the example of FIG. 17, in the list display area A33, a plurality of records in each of which the items of “name”, “MAPE impact list”, “TS”, “actual outcome value average”, “actual outcome value average for preceding month”, and “attribute relations” are associated with each other are displayed. Among these items, displayed in the item of “name” is the name of a product. In the item of “MAPE impact list”, the MAPE impact of the product is displayed. In the item of “TS”, the TS of the product is displayed. In the item of “actual outcome value average”, information indicating the actual outcome of the product for the present month is displayed. In the item of “actual outcome value average for preceding month”, information indicating the actual outcome of the product for the preceding month is displayed.

In the word cloud display area A34, elements frequently cited as the attributes of products ranked high in terms of the MAPE impact are extracted and displayed. That is, in this example, the display control section 12A extracts the attributes of products having the MAPE impacts that satisfy a predetermined condition (i.e. as a result of sorting by the MAPE impact, the rankings thereof are equal to or higher than a predetermined threshold), and displays the extracted attributes. In this display, the display control section 12A may select, from the plurality of extracted attributes, an attribute the extraction frequency of which (the number of products which have the attribute) is great, and display the selected attribute. Further, the display control section 12A may display an attribute the extraction frequency of which is great such that the attribute is highlighted (e.g. made larger in the text size for a greater frequency).

### (Product-Specific Metrics Analysis Screen)

The product-specific metrics analysis screen SC14 includes product-by-product metrics analysis results. As an example, the product-specific metrics analysis screen SC14 is a screen to which a transition is made from the MAPE impact list screen SC13 of FIG. 16 or the alert screen SC15 (described later), on the basis of the instruction from a user. In a case of a transition from the MAPE impact list screen SC13 of FIG. 16, it can be said that the display control section 12A displays an analysis result regarding the demand for a product corresponding to a selection accepted by the accepting section 11A. In a case of a transition from the alert screen SC15, it can be said that the display control section 12A displays an analysis result regarding the demand for a product corresponding to a selection accepted on the alert screen SC15 by the accepting section 11A.

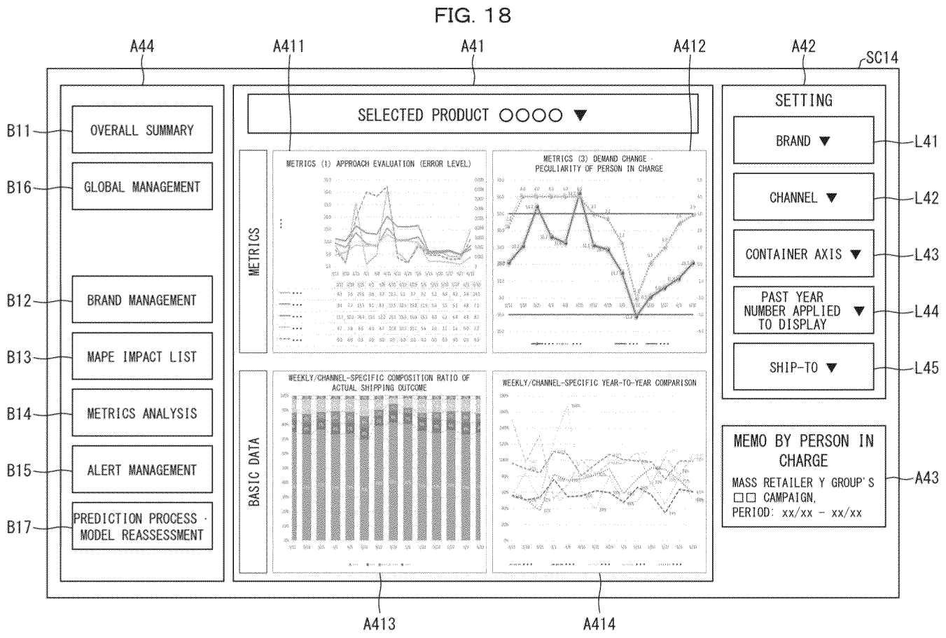

FIG. 18 is a representation of an example of the product-specific metrics analysis screen SC14. Upon selection, by a user, of any of the products included in the list on the MAPE impact list screen SC13 of FIG. 16, the display control section 12A causes the screen on the display to transition from the MAPE impact list screen SC13 to the product-specific metrics analysis screen SC14. In the example of FIG. 18, the product-specific metrics analysis screen SC14 includes a metrics analysis display area A41, a setting area A42, a memo area A43, and a menu area A44.

The metrics analysis display area A41 is an area in which to display metrics analysis results. In the example of FIG. 18, the metrics analysis display area A41 includes areas A411 and A414. In the area A411, graphs representing changes in a plurality of pieces of information each of which indicates the accuracy of a demand prediction are displayed regarding the product designated by a user. Specifically, in the example of FIG. 18, the respective graphs of absolute error, mean absolute error (MAE), root mean square error (RMSE), average absolute deviation (AVEDEV), and MAPE impact are displayed. In the graphs displayed in the area A411, the horizontal axis indicates time and date, and the vertical axis indicates the value of accuracy information (such as absolute error).

In the area A412, graphs representing changes in the f-Bias ratio and the tracking signal are displayed regarding the product designated by a user. In the graphs displayed in the area A412, the horizontal axis indicates time and date, and the vertical axis indicates the respective values of the pieces of information. The graphs displayed in the area A412 enable a user or the like to understand, for example, changes in the demand and the peculiarity of a person in charge.

In the area A413, graphs representing changes in weekly/channel-specific composition ratio of actual shipping outcome are displayed regarding the product designated by a user. In the area A414, graphs representing weekly/channel-specific year-on-year changes in actual shipping outcome are displayed regarding the product designated by a user. In the graphs of the area A414, the horizontal axis indicates time and date, and the vertical axis indicates ratio (%).

The setting area A42 includes pull-down lists L41 to L45 for a user to select a product class. The pull-down lists L41, L42, L43, L44, and L45 are for designating “brand”, “channel”, “container types”, “past year number applied to display”, and “ship-to”, respectively. Upon selection of a class by a user via any of the pull-down lists L41 to 45, the display control section 12A displays, in the graph display area A12, the metrics analysis results of a product belonging to the selected class. In the memo area A43, text inputted by the person in charge or the like of the product is displayed.

The menu area A44 includes buttons B11 to B17. The buttons B11, B12, B13, B14, B15, and B16 are for causing a screen to transition to the overall summary screen SC11, the category-specific information screen SC12, the MAPE impact list screen SC13, the product-specific metrics analysis screen SC14, the alert screen SC15, and the predicted value aggregation screen SC16, respectively. The button B17 is for causing a screen to transition to the prediction process ⋅ model reassessment screen SC18. Upon performance, by the user, of the operation of selecting any of the buttons B11 to 17, the display control section 12A displays, on the display, a screen corresponding to the selected button.

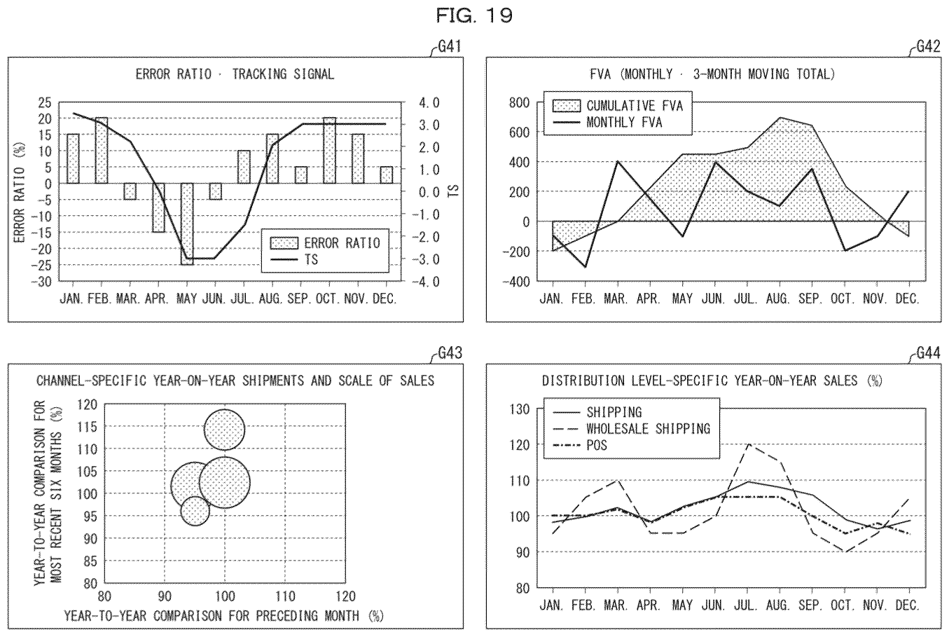

FIG. 19 is a representation of other examples of the graph displayed on the product-specific metrics analysis screen SC14. In the examples of FIG. 19, a graph G41 represents the transitions of the error ratio and the tracking signal. The graph G42 represents the monthly transitions of the FVA and the cumulative FVA. The graph G43 represents the channel-specific year-on-year shipment and the channel-specific scale of sales. The graph G44 represents the movement in distribution level-specific year-on-year sales.

### (Alert Screen)

The alert screen SC15 includes information indicating a product eligible for an alert regarding a prediction reassessment, the alert being based on the demand prediction results of a plurality of products. In other words, the display control section 12A displays, based on a plurality of indexes calculated with use of a predicted value which is a result of a demand prediction of each of the plurality of products or a planned value which is a result of a shipment plan of each of the plurality of product, information indicating a product which requires a prediction reassessment.

### (Specific Example of Alert)

Specific examples of the alert include (i) a past alert, (ii) a TS alert, (iii) a future alert, (iv) a wholesale shipping change alert, and (v) a POS change alert. The information processing apparatus 1A uses a combination of the plurality of alerts, to visualize a product which should be assigned high priority in terms of revision. This enables a user to efficiently carry out a product-by-product prediction reassessment. The thresholds used for the respective alerts are set by a user in the light of, for example, the distribution of actual error ratios, the evaluation made by a person in charge, and the like. In this case, the accepting section 11A accepts the settings of the thresholds made by a user, and the display control section 12A uses the thresholds set by the user to display a product.

### (i) Past Alert

The past alert is an alert regarding a product for which there is a divergence between the actual outcome and the plan of the past. As the past alert, an index (an example of the first index) representing the degree of divergence between the actual outcome value of sales and the predicted value of the past of each product is used. As an example, notification of the past alert is provided regarding a product having an index which indicates the planning error ratio for the preceding month or the planning error ratio for the preceding week, the index being greater than a threshold. In this case, as an example, the display control section 12A compares, with the threshold, the planning error ratio for the preceding month calculated with use of the actual outcome value and the planned value of each product for the preceding month, to identify a product eligible for the past alert. As another example, the display control section 12A may compare, with the threshold, the planning error ratio for the preceding week calculated with use of the actual outcome value and the planned value for the preceding week, to identify a product eligible for the past alert.

### (ii) TS Alert

The tracking signal (TS) alert is an alert regarding a product with an error which keeps tending toward a particular direction. In the TS alert, an index (an example of the third index) representing a trend in the difference between the predicted value and the actual outcome value is used. The TS herein is a value obtained by dividing the f-Bias by mean absolute deviation (MAD). It can be said that in a case where the TS keeps tending toward a positive direction, the risk of excess inventory is increasing, and in a case where the TS keeps tending toward a negative direction, the risk of a stockout is increasing. As an example, checking the TS enables a person in charge of practical business to carry out an early demand prediction or an early plan revision on a per-product basis.

As an example, notification of the TS alert is provided regarding a product having an absolute value of the TS for four weeks, the absolute value being greater than a threshold (e.g. “3.2”). In this case, as an example, the display control section 12A compares, with the threshold, the TS calculated with use of the weekly planned value and the weekly actual outcome value, to identify a product eligible for the TS alert.

(iii) Future Alert

The future alert is an alert based on the result of comparison between a shipment plan or a demand prediction for one future period and the latest estimated sales outcome for the same period. In the future alert, an index (an example of the second index) representing the result of comparison between the predicted value of a demand prediction or the planned value of a shipment plan for one future period and the estimated value of sales for the same period of each product is used. As an example, notification of the future alert is provided regarding a product having an index which is a difference ratio between the shipment plan or demand prediction and the latest estimated sales outcome for the same period, the index being greater than a threshold. In this case, as an example, the display control section 12A compares the difference ratio with the threshold, to identify a product eligible for the future alert.

More specifically, the index used in the future alert is calculated from estimated sales outcome for one future period (e.g. a period up to the next three weeks) and the shipment plan for the same period. The estimated sales outcome is calculated with use of the actual outcome (movement) for the same period of the preceding year.

### (iv) Wholesale Shipping Change Alert

The wholesale shipping change alert is an alert regarding a product the wholesale shipping of which significantly changes. In the wholesale shipping change alert, an index (an example of the fourth index) regarding the movement in the actual outcome value of wholesale shipping is used. As an example, notification of the wholesale shipping change alert is provided regarding a product having the change ratio of the moving average between particular periods or the year-on-year moving average for a particular period, the change ratio or the year-on-year moving average being greater than a threshold. Examples of the index of the wholesale shipping change alert include (a) an index obtained from the actual outcome for the preceding year and (b) an index obtained from the change ratio of the moving average. For products with actual outcomes for the preceding year, the above index (a) is used. For products without actual outcomes for the preceding year, the above index (b) is used.

In a case of using the index (a), as an example, the display control section 12A uses, as the index, a value obtained by dividing the moving average of the actual outcome values for a particular period (e.g. the most recent seven consecutive days) by the moving average of the actual outcome values for the same period of the preceding year, to identify, as the product eligible for the alert, a product having the index which is greater than the threshold. Using the moving average makes it possible to curb the influence of noise, and using the year-on-year moving average makes it possible to curb the influence of a seasonal factor. It is therefore possible to make a trend change prominent, and make the change easy to detect.

For the products without actual outcomes for the preceding year, the index (a) cannot be used, and the index (b) is used instead. In this case, as an example, the display control section 12A uses, as the index, a value obtained by dividing the moving average of the actual outcome values for a particular period (e.g. the most recent three days) by the moving average of the actual outcome values for a period (e.g. the seven consecutive days that precede) before the particular period, to identify, as the product eligible for the alert, a product having the index which is greater than the threshold.

### (v) POS Change Alert

The POS change alert is an alert regarding a product the point of sale (POS) of which significantly changes. In the POS change alert, an index (an example of the fourth index) regarding the movement in the actual outcome value of end-user consumption is used. As an example, notification of the POS alert is provided regarding a product having the change ratio of the moving average between particular periods or the year-on-year moving average for a particular period, the change ratio or the year-on-year moving average being greater than a threshold. As with the index of the wholesale shipping change alert described above, examples of the index of the POS change alert include (a) an index obtained from the actual outcome for the preceding year and (b) an index obtained from the change ratio of the moving average. For products with actual outcomes for the preceding year, the above index (a) is used. For products without actual outcomes for the preceding year, the above index (b) is used.

In a case of using the index (a), as an example, the display control section 12A uses, as the index, a value obtained by dividing the moving average of the actual outcome values for a particular period (e.g. the most recent seven consecutive days) by the moving average of the actual outcome values for the same period of the preceding year, to identify, as the product eligible for the alert, a product having the index which is greater than the threshold. Using the moving average makes it possible to curb the influence of noise, and using the year-on-year moving average makes it possible to curb the influence of a seasonal factor. It is therefore possible to make a trend change prominent, and make the change easy to detect.

For the products without actual outcomes for the preceding year, the index (a) cannot be used, and the index (b) is used instead. In this case, as an example, the display control section 12A uses, as the index, a value obtained by dividing the moving average of the actual outcome values for a particular period (e.g. the most recent three days) by the moving average of the actual outcome values for a period (e.g. the seven consecutive days that precede) before the particular period, to identify, as the product eligible for the alert, a product having the index which is greater than the threshold.

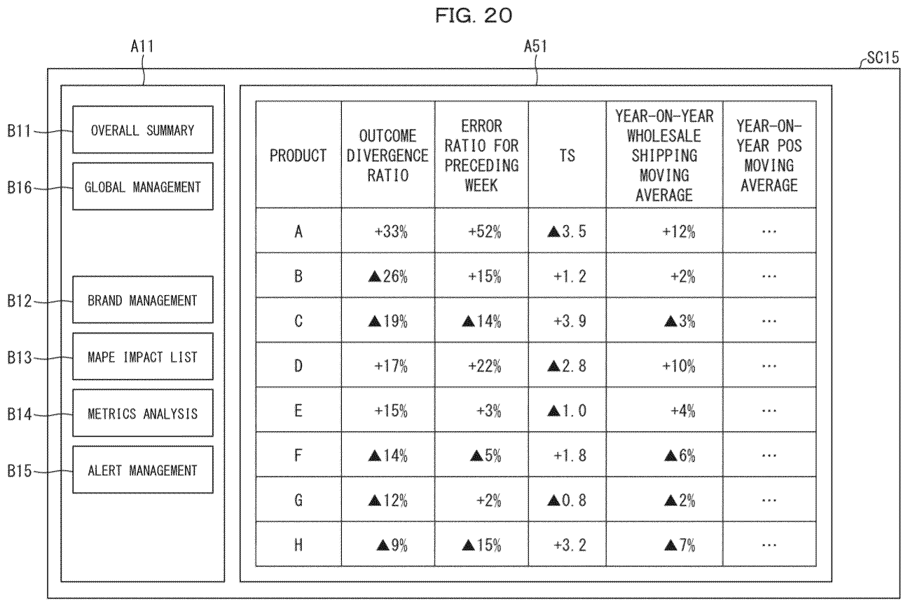

FIG. 20 is a representation of an example of the alert screen SC15. In the example of FIG. 20, the alert screen SC15 includes a menu area A11 and an alert display area A51. In the alert display area A51, a list of products eligible for an alert is displayed. In the example of FIG. 20, displayed in the alert display area A51 are a plurality of records in each of which the items of “product”, “outcome divergence ratio”, “error ratio for preceding week”, “TS”, “year-on-year wholesale shipping moving average”, and “year-on-year POS moving average” are associated with each other. In the item “product”, information (e.g. product name, product ID, or the like) for identifying a product is displayed. In the item “outcome divergence ratio”, the difference ratio between the latest shipment plan and the short-term outcome forecast is displayed. The difference ratio is the index of (iii) future alert.

In the item “error ratio for preceding week”, the planning error ratio for the preceding week, the planning error ratio being the index of (i) past alert, is displayed. In the item “TS”, the TS, which is the index of (ii) TS alert, is displayed. In the item “year-on-year wholesale shipping moving average”, the year-on-year wholesale shipping moving average, which is the index of (iv) wholesale shipping change alert, is displayed. In the item “year-on-year POS moving average”, the year-on-year POS moving average, which is the index of (v) POS change alert, is displayed.

In example of FIG. 20, a plurality of products having sorted in descending order of the outcome divergence ratio are displayed. In this display, in each of the alerts, a product having the corresponding index greater than the threshold is displayed so as to be highlighted (e.g. changed in color, made large in the text size) compared with the other products. However, the alert screen SC15 is not limited to the example of FIG. 20. On the alert screen SC15, a plurality of products may be displayed so as to, for example, be sorted in descending order of the index of an alert other than the future alert.

On the alert screen SC15, the display control section 12A may display a list of products sorted according to a sorting criterion obtained by combining the plurality of indexes of the alerts. For example, the display control section 12A may display a list of products sorted in descending order of the value of summation of the indexes of the past alert and the future alert.

The display control section 12A may extract, from the plurality of products, a product having an index which is greater than the corresponding threshold, and display the product. In this display, the display control section 12A may display a list of products based on an index of a combination of a plurality of types of alerts. For example, the display control section 12A may display, on the alert screen SC15, products which satisfy all of the following conditions (1) to (3): (1) the absolute value of the outcome divergence ratio is not less than 20%; (2) the absolute value of the error ratio for preceding week is not less than 20%; and (3) the sign of the outcome divergence ratio is the same as the sign of the error ratio for preceding week.

The display of the alert screen SC15 is not limited to a list display. As an example, the display control section 12A may display an image in which at least some of the plurality of products are plotted in a feature space (two-dimensional space, three-dimensional space, etc.) defined by the plurality of indexes of alerts. More specifically, for example, the display control section 12A may display the image in which a plurality of products are plotted in the three-dimensional space defined by the x axis representing the index of the past alert, the y axis representing the index of the future alert, and the z axis representing the index of the TS alert. In this display, the display control section 12A may extract, from the plurality of products, a product having an index which satisfies a predetermined condition (e.g. the index is greater than a threshold) and display an image in which the extracted product is plotted in the three-dimensional space. As another example, the display control section 12A may display, for example, a radar chart of a plurality of indexes product by product.

While the alert display area A51 is displayed, it is possible for a user to perform the operation of selecting a product included in the list. In other words, on the alert screen SC15, the accepting section 11A accepts a user's selection with respect to a product displayed in the alert display area A51. Upon the selection of a product by a user from the list, the display control section 12A displays the product-specific metrics analysis screen SC14 regarding the selected product. In other words, the display control section 12A displays an analysis result regarding demand for a product corresponding to the selection accepted.

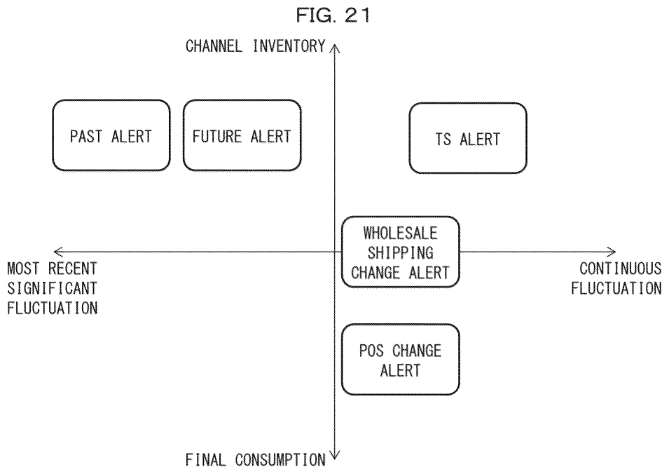

FIG. 21 is a diagram visually illustrating the characteristics of various alerts. As illustrated, the TS alert, the past alert, and the future alert are the mechanisms for catching a product having a large error ratio in terms of channel inventory, while the POS change alert is the mechanism for catching a product having a large error ratio in terms of final consumption. Further, the TS alert, the wholesale shipping change alert, and the POS alert are the mechanism for catching a product having the error ratio which is a continuously large, while the past alert and the future alert are the mechanism for catching a product having the most recent error ratio which is large. In this manner, the TS alert, the past alert, the future alert, the wholesale shipping change alert, and the POS change alert differ in characteristics from each other. By combining a plurality of alerts, the information processing apparatus 1A makes it possible to more efficiently determine a product the prediction of which should be preferentially reassessed.

### (Prediction Process ⋅ Model Reassessment Screen)

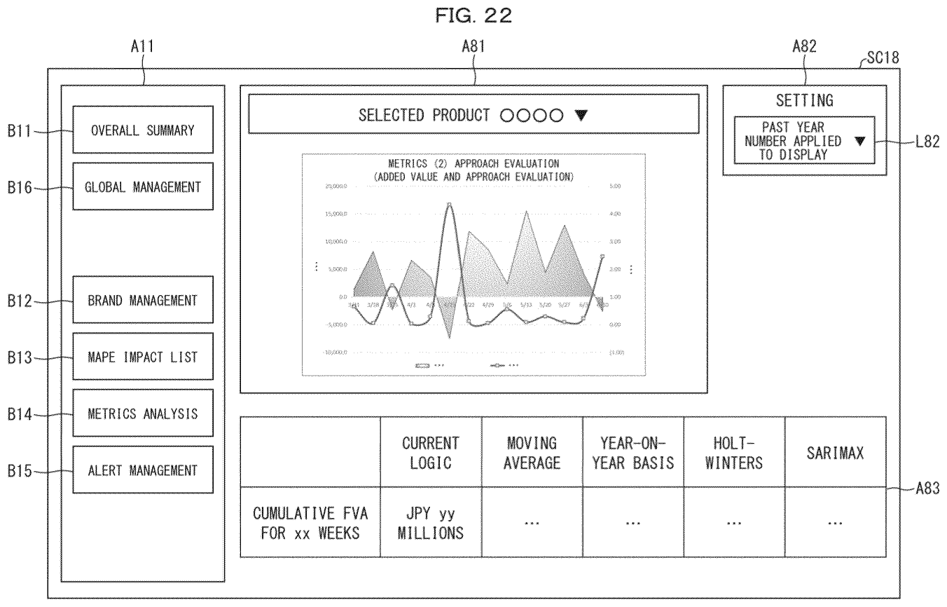

FIG. 22 is a representation of an example of a prediction process ⋅ model reassessment screen SC18. Upon selection of the button B17 by a user on the product-specific metrics analysis screen SC14, the display control section 12A causes the displayed screen to transition from the product-specific metrics analysis screen SC14 to the prediction process ⋅ model reassessment screen SC18.

In the example of FIG. 22, the prediction process ⋅ model reassessment screen SC18 includes a menu area A11, a graph display area A81, a setting area A82, and a table display area A83.

In the graph display area A81, graphs representing changes in the FVA and a measurement error (scaled error) are displayed. In the graphs displayed in the graph display area A81, the horizontal axis indicates time and date and the vertical axis indicates the FVA or the measurement error.

The setting area A82 includes a pull-down list L82 for a user to select a year number applied to the display. The pull-down list L82 is for designating the “past year number applied to display”. Upon selection, by a user, of a period included in the list of the pull-down list L81, the display control section 12A displays, in the graph display area A81, a graph representing the FVA and the measurement error for the selected period.

Displayed in the table display area A83 is information which indicates prediction accuracies obtained via a plurality of respective prediction models.

### (Configuration of User Terminal)

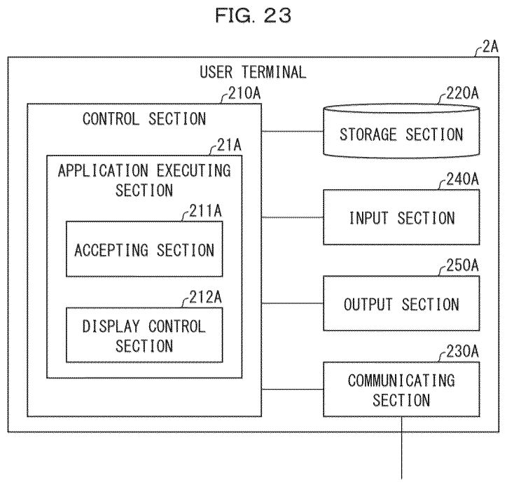

FIG. 23 is a block diagram m illustrating the configuration of the user terminal 2A. The user terminal 2A includes a control section 210A, a storage section 220A, a communicating section 230A, an input section 240A, and an output section 250A. As an example, the user terminal 2A is a general-purpose computer. In the storage section 220A, various kinds of information to be referred to by the control section 210A are stored. The communicating section 230A communicates with an apparatus (information processing apparatus 1A, etc.) external to the user terminal 2A via a communication line N.

### (Input Section ⋅ Output Section)

The input section 240A is a component for accepting input to the user terminal 2A, and includes inputting equipment such as, for example, a keyboard, a mouse, a touch panel, a camera, or a microphone. Further, the input section 240A may be a component for accepting data from inputting equipment via an interface such as a USB, for example. The output section 250A is a component through which output from the user terminal 2A is performed, and includes outputting equipment such as, for example, a display, a printer, a touch panel, or a speaker. The output section 250A may have the configuration in which an interface such as, for example, a USB is included and data is outputted to outputting equipment via the interface.

### (Control Section)

The control section 210A includes an application executing section 21A. The application executing section 21A is provided by the control section 210A retrieving the instructions of an application program stored in the storage section 220A and executing the instructions. The application executing section 21A executes the application program stored in the storage section 220A, to carry out a process of transmitting, to the information processing apparatus 1A, information which indicates the shape, materials, and formative conditions of a molded product being molded, and a process of displaying simulation results of the molded product. Examples of the application implemented by the application executing section 21A include, but not limited to, a general-purpose web browser. The application executing section 21A may be a dedicated application for communicating with the information processing apparatus 1A to assist in designing a molded product.

The application executing section 21A includes an accepting section 211A and a display control section 212A. The accepting section 211A accepts designation, selection, and the like performed by a user. The display control section 212A displays various screens on a display on the basis of data received from the information processing apparatus 1A.

### (Flow of Demand Prediction Assistance Method)

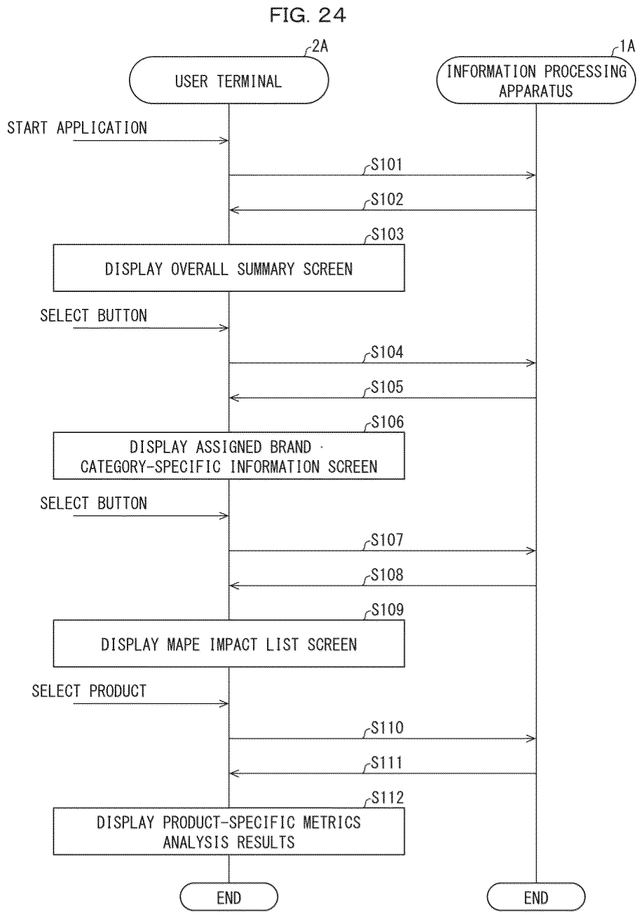

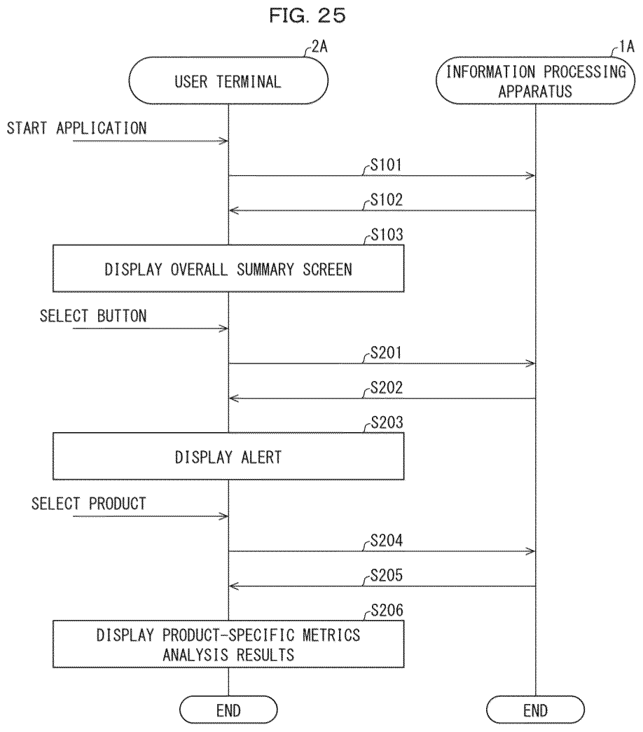

FIGS. 24 and 25 are sequence diagrams illustrating examples of the flow of a demand prediction assistance method carried out by the information processing apparatus 1A. With reference to the example of FIG. 24, the case of displaying various screens on the display of the user terminal 2A is described here. Upon performance, by the user of the user terminal 2A via inputting equipment, of the operation for starting an application, the application executing section 21A transmits a request for the overall summary screen SC11 to the information processing apparatus 1A in step S101.

Upon reception of the request by the information processing apparatus 1A from the user terminal 2A, the display control section 12A transmits data representing the overall summary screen SC11, to the user terminal 2A in step S102. The user terminal 2A displays the overall summary screen SC11 on the display on the basis of the received data in step S103.

While the overall summary screen SC11 is displayed on the display, it is possible for the user to perform various operations including the operation of selecting a button displayed in the menu area A11. For example, upon selection of the button B12 on the overall summary screen SC11 of FIG. 10, the application executing section 21A transmits a request for the brand ⋅ category-specific information screen SC12, which corresponds to the button B12 selected, to the information processing apparatus 1A in step S104.

Upon reception of the request by the information processing apparatus 1A from the user terminal 2A, the display control section 12A transmits data representing the assigned brand ⋅ category-specific information screen SC12, to the user terminal 2A in step S105. In step S106, the user terminal 2A displays the assigned brand ⋅ category-specific information screen SC12 on the display on the basis of the data received from the information processing apparatus 1A. In the assigned brand ⋅ category-specific information screen SC12, a plurality of graphs representing demand prediction accuracies such as MAPE, f-Bias ratio, and FVA are displayed, as illustrated in FIG. 13.

While the assigned brand ⋅ category-specific information screen SC12 is displayed on the display, it is possible for the user to perform various operations including the operation of selecting a button displayed in the menu area A11. For example, upon selection of the button B13 on the assigned brand ⋅ category-specific information screen SC12 of FIG. 13, the application executing section 21A transmits a request for the MAPE impact list screen SC13, which corresponds to the button B13 selected, to the information processing apparatus 1A in step S107.

Upon reception of the request by the information processing apparatus 1A from the user terminal 2A, the display control section 12A transmits data representing the MAPE impact list screen SC13, to the user terminal 2A in step S108. In step S109, the user terminal 2A displays the MAPE impact list screen SC13 on the display on the basis of the data received from the information processing apparatus 1A. In other words, in a case where the accepting section 11A accepts the instruction that a prediction accuracy should be displayed product by product (step S107), the display control section 12A displays, based on the MAPE impact, a list of products which have high possibilities of requiring prediction reassessments, regarding the plurality of products belonging to the designated class (steps S108 and S109).

While the MAPE impact list screen SC13 is displayed on the display, it is possible for the user to perform various operations including the operation of selecting a product included in the list. For example, upon selection of any of the products of the list on the MAPE impact list screen SC13 of FIG. 16, the application executing section 21A transmits data representing the selected product, to the information processing apparatus 1A in step S110.

Upon reception of the data by the information processing apparatus 1A from the user terminal 2A, the display control section 12A transmits data representing metrics analysis results product by product, to the user terminal 2A in step S111. In step S112, the user terminal 2A displays the metrics analysis results on the display on the basis of the data received from the information processing apparatus 1A.

FIG. 25 is a sequence diagram illustrating another example of the flow of the demand prediction assistance method carried out by the information processing apparatus 1A. The processes of steps S101 to S103 of FIG. 25 are the same as those of steps S101 to S103 of FIG. 24. Upon selection of the button B15 on the overall summary screen SC11 of FIG. 10, the application executing section 21A transmits a request for the alert screen SC15, which corresponds to the button B15 selected, to the information processing apparatus 1A in step S201.

Upon reception of the request by the information processing apparatus 1A from the user terminal 2A, the display control section 12A transmits data representing the alert screen SC15, to the user terminal 2A in step S202. In step S203, the user terminal 2A displays the alert screen SC15 on the display on the basis of the data received from the information processing apparatus 1A.

While the alert screen SC15 is displayed on the display, it is possible for the user to perform various operations including the operation of selecting a product included in the list. For example, upon selection of any of the products of the list on the alert screen SC15 of FIG. 20, the application executing section 21A transmits data representing the selected product, to the information processing apparatus 1A in step S204.

Upon reception of the data by the information processing apparatus 1A from the user terminal 2A, the display control section 12A transmits data representing metrics analysis results product by product, to the user terminal 2A in step S205. In step S206, the user terminal 2A displays the metrics analysis results on the display on the basis of the data received from the information processing apparatus 1A. In other words, after the display control section 12A displays a list of products eligible for an alert regarding a prediction reassessment, upon acceptance, by the accepting section 11A, of the selection of a product included in the displayed list, the display control section 12A displays the metrics analysis results of the product corresponding to the accepted selection.

### (Example Advantages of Information Processing Apparatus)

As above, in the information processing apparatus 1A, the plurality of indexes used for the alerts include a TS (third index) which indicates a trend in the difference between the predicted value of a demand prediction and the actual outcome value. The TS is the index representing a trend in the difference between the predicted value of demand and the actual outcome value. Thus, with the combined use of the TS alert and another alert, the information processing apparatus 1A provides an example advantage of making it possible to more efficiently reassess a prediction in consideration of continuous demand fluctuations.

Further, in the information processing apparatus 1A, the plurality of indexes used for the alerts include an index (the index of the wholesale shipping change alert) regarding the movement in the actual outcome value in wholesale shipping or an index (the index of the POS change alert) regarding the movement in the actual outcome value of end-user consumption. The wholesale shipping change alert is the alert regarding a product with a significantly fluctuating actual wholesale shipping outcome. Thus, with the combined use of the wholesale shipping change alert and another alert, the information processing apparatus 1A provides an example advantage of making it possible to more efficiently reassess a prediction in consideration of the fluctuations of the actual outcome of wholesale shipping. Further, the POS change alert is the alert regarding a product with a significantly fluctuating actual POS outcome. Thus, with the combined use of the POS change alert and another alert, the information processing apparatus 1A provides an example advantage of making it possible to more efficiently reassess a prediction in consideration of the fluctuations of the actual outcome of the POS.

Further, in the information processing apparatus 1A, the display control section 12A displays a list of products sorted according to a sorting criterion obtained by combining the indexes of a plurality of alerts. Thus, checking the displayed list provides an example advantage of making it easy for a user to efficiently understand a product the prediction of which should be preferentially reassessed.

Further, in the information processing apparatus 1A, the display control section 12A displays an image in which at least some of the plurality of products are plotted in a feature space defined by the plurality of indexes of alerts. Thus, checking the displayed image makes it possible to visually understand indexes of each of the plurality of products. This provides an example advantage of making it easy for a user to efficiently understand a product the prediction of which should be preferentially reassessed.

Further, in the information processing apparatus 1A, the display control section 12A extracts, from the plurality of products, a product having an alert index which is greater than a threshold and displays the product, and the accepting section 11A accepts the setting of the threshold made by a user. Thus, the information processing apparatus 1A provides an example advantage of making it possible to perform display in which the intention of a user is reflected and thereby make it easy for the user to understand a product the prediction of which should be reassessed.

### [Software Implementation Example]

Some or all of the functions of the demand prediction assistance apparatus 1, the information processing apparatus 1A, and the user terminal 2A (hereinafter, also referred to as “each apparatus above”) may be implemented by hardware such as an integrated circuit (IC chip), or may be implemented by software.

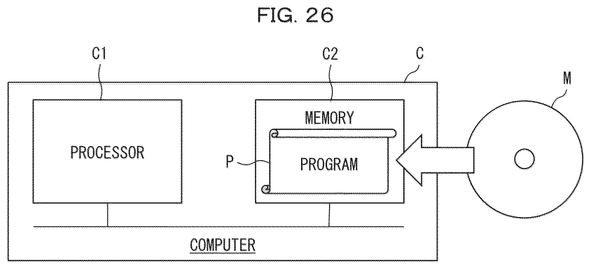

In the latter case, each apparatus above is provided by, for example, a computer that executes instructions of a program that is software implementing the foregoing functions. An example (hereinafter, computer C) of such a computer is illustrated in FIG. 26. FIG. 26 is a block diagram illustrating a hardware configuration of the computer C which functions as each apparatus above.

The computer C includes at least one processor C1 and at least one memory C2. The memory C2 has recorded thereon a program P for causing the computer C to operate as each apparatus above. The processor C1 of the computer C retrieves the program P from the memory C2 and executes the program P, so that the functions of each apparatus above are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory tangible recording medium M capable of being read by the computer C. The recording medium M can be, for example, a tape, a disk, a card, a semiconductor memory, a programmable logic circuit, or the like. The computer C can obtain the program P via such a recording medium M. The program P can be transmitted via a transmission medium. Examples of such a transmission medium can include a communication network and a broadcast wave. The computer C can obtain the program P also via such a transmission medium.

The above-described functions of each apparatus above may be implemented by a single processor provided in a single computer, may be implemented by the cooperation among a plurality of processors provided in a single computer, or may be implemented by the cooperation among a plurality of processors provided in a plurality of respective computers. Further, the program for causing each apparatus above to implement the above-described functions may be stored in a single memory provided in a single computer, may be stored in a distributed manner in a plurality of memories provided in a single computer, or may be stored in a distributed manner in a plurality of memories provided in a plurality of respective computers.

### [Additional Remark 1]

### [Additional Remark A]

The whole or part of the example embodiments disclosed above can be described as, but not limited to, the following supplementary notes, and the present invention can be altered in various ways by a skilled person in the art within the scope of the claims.

### (Supplementary Note A1)

A demand prediction assistance apparatus including: a first displaying means for displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
an accepting means for accepting a selection made by a user with respect to a product displayed by the first displaying means; and
a second displaying means for displaying an analysis result regarding demand for a product corresponding to the selection accepted by the accepting means.

### (Supplementary Note A2)

The demand prediction assistance apparatus described in supplementary note A1, in which the plurality of indexes includes a third index which indicates a trend in a difference between the predicted value and the actual outcome value.

### (Supplementary Note A3)

The demand prediction assistance apparatus described in supplementary note A1 or A2, in which the plurality of indexes includes a fourth index regarding movement in an actual outcome value of wholesale shipping or an actual outcome value of end-user consumption.

### (Supplementary Note A4)

The demand prediction assistance apparatus described in any one of supplementary notes A1 to A3, in which the second displaying means is configured to display a list of products sorted according to a sorting criterion obtained by combining the plurality of indexes.

### (Supplementary Note A5)

The demand prediction assistance apparatus described in any one of supplementary notes A1 to A4, in which the second displaying means is configured to display an image in which at least some of the plurality of products are plotted in a feature space defined by the plurality of indexes.

### (Supplementary Note A6)

The demand prediction assistance apparatus described in any one of supplementary notes A1 to A5, in which the second displaying means is configured to extract, from the plurality of products, a product having an index which is greater than a threshold, the index being included in the plurality of indexes, and displays the product, and
the accepting means is configured to accept a setting of the threshold made by the user.

### [Additional Remark B]

The whole or part of the example embodiments disclosed above can be described as, but not limited to, the following supplementary notes, and the present invention can be altered in various ways by a skilled person in the art within the scope of the claims.

### (Supplementary Note B1)

A demand prediction assistance method including: at least one processor displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
the at least one processor accepting a selection made by a user with respect to a product displayed in the displaying of the information; and
the at least one processor displaying an analysis result regarding demand for a product corresponding to the selection accepted in the accepting.

### (Supplementary Note B2)

The demand prediction assistance method described in supplementary note B1, in which the plurality of indexes includes a third index which indicates a trend in a difference between the predicted value and the actual outcome value.

### (Supplementary Note B3)

The demand prediction assistance method described in supplementary note B1 or B2, in which the plurality of indexes includes a fourth index regarding movement in an actual outcome value of wholesale shipping or an actual outcome value of end-user consumption.

### (Supplementary Note B4)

The demand prediction assistance method described in any one of supplementary notes B1 to B3, in which in the displaying of the analysis result, the at least one processor displays a list of products sorted according to a sorting criterion obtained by combining the plurality of indexes.

### (Supplementary Note B5)

The demand prediction assistance method described in any one of supplementary notes B1 to B4, in which in the displaying of the analysis result, the at least one processor displays an image in which at least some of the plurality of products are plotted in a feature space defined by the plurality of indexes.

### (Supplementary Note B6)

The demand prediction assistance method described in any one of supplementary notes B1 to B5, in which in the displaying of the analysis result, the at least one processor extracts, from the plurality of products, a product having an index which is greater than a threshold, the index being included in the plurality of indexes, and displays the product, and
in the accepting, the at least one processor accepts a setting of the threshold made by the user.

### [Additional Remark C]

The whole or part of the example embodiments disclosed above can be described as, but not limited to, the following supplementary notes, and the present invention can be altered in various ways by a skilled person in the art within the scope of the claims.

### (Supplementary Note C1)

A demand prediction assistance program for causing a computer to function as a demand prediction assistance apparatus, the program causing the computer to function as:
a first displaying means for displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
an accepting means for accepting a selection made by a user with respect to a product displayed by the first displaying means; and
a second displaying means for displaying an analysis result regarding demand for a product corresponding to the selection accepted by the accepting means.

### (Supplementary Note C2)

The demand prediction assistance program described in supplementary note C1, in which the plurality of indexes includes a third index which indicates a trend in a difference between the predicted value and the actual outcome value.

### (Supplementary Note C3)

The demand prediction assistance program described in supplementary note C1 or C2, in which the plurality of indexes includes a fourth index regarding movement in an actual outcome value of wholesale shipping or an actual outcome value of end-user consumption.

### (Supplementary Note C4)

The demand prediction assistance program described in any one of supplementary notes C1 to C3, in which the second displaying means is configured to display a list of products sorted according to a sorting criterion obtained by combining the plurality of indexes.

### (Supplementary Note C5)

The demand prediction assistance program described in any one of supplementary notes C1 to C4, in which the second displaying means is configured to display an image in which at least some of the plurality of products are plotted in a feature space defined by the plurality of indexes.

### (Supplementary Note C6)

The demand prediction assistance program described in any one of supplementary notes C1 to C5, in which the second displaying means is configured to extract, from the plurality of products, a product having an index which is greater than a threshold, the index being included in the plurality of indexes, and displays the product, and
the accepting means is configured to accept a setting of the threshold made by the user.

### [Additional Remark D]

The whole or part of the example embodiments disclosed above can be described as, but not limited to, the following supplementary notes, and the present invention can be altered in various ways by a skilled person in the art within the scope of the claims.

### (Supplementary Note D1)

A demand prediction assistance apparatus including at least one processor, the at least one processor carrying out:
a first displaying process of displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
an accepting process of accepting a selection made by a user with respect to a product displayed in the first displaying process; and
a second displaying process of displaying an analysis result regarding demand for a product corresponding to the selection accepted in the accepting process.

The demand prediction assistance apparatus may further include a memory. The memory may have stored therein a program for causing the at least one processor to carry out each of the processes.

### (Supplementary Note D2)

The demand prediction assistance apparatus described supplementary note D1, in which the plurality of indexes includes a third index which indicates a trend in a difference between the predicted value and the actual outcome value.

### (Supplementary Note D3)

The demand prediction assistance apparatus described in supplementary note D1 or D2, in which the plurality of indexes includes a fourth index regarding movement in an actual outcome value of wholesale shipping or an actual outcome value of end-user consumption.

### (Supplementary Note D4)

The demand prediction assistance apparatus described in any one of supplementary notes D1 to D3, in the second displaying process, the at least one processor displays a list of products sorted according to a sorting criterion obtained by combining the plurality of indexes.

### (Supplementary Note D5)

The demand prediction assistance apparatus described in any one of supplementary notes D1 to D4, in which in the second displaying process, the at least one processor displays an image in which at least some of the plurality of products are plotted in a feature space defined by the plurality of indexes.

### (Supplementary Note D6)

The demand prediction assistance apparatus described in any one of supplementary notes D1 to D5, in which in the second displaying process, the at least one processor extracts, from the plurality of products, a product having an index which is greater than a threshold, the index being included in the plurality of indexes, and displays the product, and
in the accepting process, the at least one processor accepts a setting of the threshold made by the user.

### [Additional Remark E]

The whole or part of the example embodiments disclosed above can be described as, but not limited to, the following supplementary notes, and the present invention can be altered in various ways by a skilled person in the art within the scope of the claims.

### (Supplementary Note E1)

A non-transitory recording medium having recorded thereon a demand prediction assistance program for causing a computer to function as a demand prediction assistance apparatus,
the demand prediction assistance program causing the computer to carry out:
a first displaying process of displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
an accepting process of accepting a selection made by a user with respect to a product displayed in the first displaying process; and
a second displaying process of displaying an analysis result regarding demand for a product corresponding to the selection accepted in the accepting process.

### REFERENCE SIGNS LIST

1: Demand prediction assistance apparatus
11: First displaying section
12: Accepting section
13: Second displaying section
1A: Information processing apparatus
2A: User terminal
10A, 210A: Control section
11A, 101A, 211A: Accepting section
12A, 212A: Display control section
20A, 220A: Storage section
21A: Application executing section

1. A demand prediction assistance apparatus, comprising
at least one processor, the at least one processor carrying out:
a first displaying process of displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
an accepting process of accepting a selection made by a user with respect to a product displayed in the first displaying process; and
a second displaying process of displaying an analysis result regarding demand for a product corresponding to the selection accepted in the accepting process.

2. The demand prediction assistance apparatus according to claim 1, wherein
the plurality of indexes includes a third index which indicates a trend in a difference between the predicted value and the actual outcome value.

3. The demand prediction assistance apparatus according to claim 1, wherein
the plurality of indexes includes a fourth index regarding movement in an actual outcome value of wholesale shipping or an actual outcome value of end-user consumption.

4. The demand prediction assistance apparatus according to claim 1, wherein
in the second displaying process, the at least one processor displays a list of products sorted according to a sorting criterion obtained by combining the plurality of indexes.

5. The demand prediction assistance apparatus according to claim 1, wherein
in the second displaying process, the at least one processor displays an image in which at least some of the plurality of products are plotted in a feature space defined by the plurality of indexes.

6. The demand prediction assistance apparatus according to claim 1 wherein
in the second displaying process, the at least one processor extracts, from the plurality of products, a product having an index which is greater than a threshold, the index being included in the plurality of indexes, and displays the product, and
in the accepting process, the at least one processor accepts a setting of the threshold made by the user.

7. A demand prediction assistance method, comprising:
at least one processor displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
the at least one processor accepting a selection made by a user with respect to a product displayed in the displaying of the information; and
the at least one processor displaying an analysis result regarding demand for a product corresponding to the selection accepted in the accepting.

8. A computer-readable non-transitory recording medium having recorded thereon a program for causing a computer to function as a demand prediction assistance apparatus, the program causing the computer to carry out:
a first displaying process of displaying, based on a plurality of indexes, information indicating a product which requires a prediction reassessment, the plurality of indexes being calculated with use of a predicted value which is a result of a demand prediction of each of a plurality of products or a planned value which is a result of a shipment plan of each of the plurality of products, the plurality of indexes including (i) a first index which indicates a degree of divergence between an actual outcome value of past sales and the predicted value of each of the plurality of products and (ii) a second index which indicates a result of comparison between the predicted value or the planned value for one future period and an estimated value of sales for the one future period of each of the plurality of products;
an accepting process of accepting a selection made by a user with respect to a product displayed in the first displaying process; and
a second displaying process of displaying an analysis result regarding demand for a product corresponding to the selection accepted in the accepting process.
